(19) United States
(12) Patent Application Publication
(10) Pub. No.: US 2026/0064997 A1
(43) Pub. Date: Mar. 5, 2026

(54) ELECTRONIC DEVICE FOR TRANSLATING AUDIO AND STORAGE MEDIUM THEREOF

(71) Applicant: Samsung Electronics Co., Ltd., Suwon-si (KR)

(72) Inventors: Chunwoo RYU, Suwon-si (KR); Gupil CHEONG, Suwon-si (KR); Doosuk KANG, Suwon-si (KR); Heejae YOON, Suwon-si (KR)

(21) Appl. No.: 19/313,051

(22) Filed: Aug. 28, 2025

Related U.S. Application Data
(63) Continuation of application No. PCT/KR2025/012752, filed on Aug. 22, 2025.

(30) Foreign Application Priority Data
Aug. 28, 2024 (KR) 10-2024-0116213
Nov. 8, 2024 (KR) 10-2024-0158343
Jul. 25, 2025 (KR) 10-2025-0101126

(51) Int. Cl. G06F 40/58; G06F 3/16; G10L 15/00; H04H 60/37

(52) U.S. Cl. CPC G06F 40/58; G06F 3/165; G10L 15/005; H04H 60/375

(57) ABSTRACT

An electronic device may include communication circuitry, a processor(s), and memory storing instructions. The instructions may, when executed by the processor(s), may cause the electronic device to receive synchronization information associated with reception of a broadcast isochronous stream service from a source electronic device, transmit the synchronization information to an external electronic device, so that the external electronic device is capable of synchronizing with the source electronic device based on the synchronization information and receiving audio data broadcasted from the source electronic device, receive first audio data for the BIS service broadcasted from the source electronic device; based on identifying that the first audio data is represented in a first language and the first language is different from a designated second language, translate the first audio data into second audio data represented in the second language, and transmit the second audio data to the external electronic device, so that the external electronic device outputs the second audio data.

### CROSS-REFERENCE TO RELATED APPLICATIONS

This application is a continuation application of International Application No. PCT/KR2025/012752 designating the United States, filed on Aug. 22, 2025, in the Korean Intellectual Property Receiving Office and claiming priority to Korean Patent Application No. 10-2024-0116213, filed on Aug. 28, 2024, Korean Patent Application No. 10-2024-0158343, filed on Nov. 8, 2024, and Korean Patent Application No. 10-2025-0101126, filed on Jul. 25, 2025, the disclosures of which are all hereby incorporated by reference herein in their entireties.

### BACKGROUND

### Field

Certain example embodiments may relate to an electronic device translating audio and/or a storage medium thereof.

### Description of Related Art

Bluetooth communication technology may suggest a short-range wireless communication technology that enables electronic devices to be connected to each other for exchanging data or information. Bluetooth communication technology may have Bluetooth legacy (or classic) communication technology or Bluetooth low energy (BLE) communication technology and have various kinds of topology, such as piconet or scatternet.

Recently in wide use are electronic devices adopting Bluetooth communication technology. For example, a pair of earbuds that may be respectively worn on both ears of the user are widely used as an ear-wearable device. An ear-wearable device may provide various functions. For example, an ear-wearable device may include a microphone to identify the user's voice, thereby transmitting data for the user's voice to an electronic device (e.g., a smartphone). Further, the ear-wearable device may include a speaker to output the audio data received from an electronic device (e.g., a smartphone) to through the speaker.

The ear-wearable device may include a primary earbud (e.g., the right earbud) and a secondary earbud (e.g., the left earbud) that may be connected to an electronic device (e.g., a smart phone). The primary earbud may transmit voice data to the electronic device through connection with the electronic device, and the electronic device may transmit audio data (or audio content) to the primary earbud. The primary earbud may receive audio data (or audio content) from the electronic device through wireless communication and may output the audio data through the speaker. The secondary earbud may be synchronized with the primary earbud, outputting the audio data received from the electronic device through the speaker.

A wireless audio output device, such as an ear-wearable device or a Bluetooth speaker, may be connected to an external electronic device based on Bluetooth communication to perform the above-described operations. To that ends, the wireless audio output device may perform inquiry, inquiry scan, page, and page scan based on Bluetooth classic and/or perform BLE advertising and BLE scan based on BLE.

The BLE advertising may indicate an operation for periodically broadcasting advertising data through an advertising physical channel, and the BLE scan may indicate an operation for monitoring reception of the advertising data.

The above-described information may be provided as related art for the purpose of helping understanding of the disclosure. No claim or determination is made as to whether any of the foregoing is applicable as background art in relation to the disclosure.

### SUMMARY

Certain example embodiments relate to an electronic device for translating audio and/or a storage medium thereof.

Certain example embodiments may provide an electronic device for receiving and translating broadcast audio and a storage medium thereof.

Certain example embodiments may provide an electronic device for transmitting translated audio to a wearable device and a storage medium thereof.

Certain example embodiments may provide an electronic device for providing text data related to translated audio and related information and a storage medium thereof.

Certain example embodiments may provide an electronic device for rebroadcasting translated audio and a storage medium thereof.

An electronic device according to an example embodiment may comprise communication circuitry configured to support Bluetooth communication, memory storing instructions, and at least one processor, comprising processing circuitry operatively connected, directly or indirectly, to the communication circuitry and the memory. The instructions may, when executed by the at least one processor individually and/or collectively, may cause the electronic device to receive, through the communication circuitry, synchronization information associated with reception of a broadcast isochronous stream (BIS) service from a source electronic device. The instructions may, when executed by the at least one processor individually and/or collectively, may cause the electronic device to transmit, through the communication circuitry, the synchronization information to an external electronic device, so that the external electronic device is capable of synchronizing with the source electronic device based on the synchronization information and receiving audio data broadcasted from the source electronic device. The instructions may, when executed by the at least one processor individually and/or collectively, may cause the electronic device to receive, through the communication circuitry, first audio data for the BIS service broadcasted from the source electronic device. The instructions may, when executed by the at least one processor individually and/or collectively, may cause the electronic device to, based on identifying that the first audio data is represented in a first language and the first language is different from a designated second language, translate the first audio data into second audio data represented in the second language. The instructions may, when executed by the at least one processor individually and/or collectively, cause the electronic device to transmit the second audio data to the external electronic device through the communication circuitry, so that the external electronic device outputs the second audio data.

According to an example embodiment, in a non-transitory, computer-readable storage medium storing one or more programs, the one or more programs may include instructions that, when individually and/or collectively executed by at least one processor, may cause an electronic device to receive synchronization information associated with reception of a broadcast isochronous stream (BIS) service from a source electronic device, transmit the synchronization information to an external electronic device, so that the external electronic device is capable of synchronizing with the source electronic device based on the synchronization information and receiving audio data broadcasted from the source electronic device, receive first audio data for the BIS service broadcasted from the source electronic device; based on identifying that the first audio data is represented in a first language and the first language is different from a designated second language, translate the first audio data into second audio data represented in the second language, and transmit the second audio data to the external electronic device, so that the external electronic device outputs the second audio data.

Objects of the disclosure are not limited to the foregoing, and other unmentioned objects would be apparent to one of ordinary skill in the art from the following description.

### BRIEF DESCRIPTION OF DRAWINGS

FIG. 1 is a view illustrating an electronic device in a network environment according to various embodiments;

FIG. 2 is a view illustrating connection between electronic devices based on short-range wireless communication according to an example embodiment;

FIG. 3 is a view illustrating a configuration of an electronic device supporting short-range wireless communication according to an example embodiment;

FIG. 4 is a view illustrating a BIS assistant role according to an example embodiment;

FIG. 5 is a view illustrating Bluetooth LE (BLE) advertising according to an example embodiment;

FIG. 6 is a view illustrating BIG information including BIG parameters according to an example embodiment;

FIG. 7 is a view illustrating a BIG event and a BIS event according to an example embodiment;

FIGS. 8, 9, and 10 are views illustrating transmission of BIS data packets according to example embodiments;

FIG. 11 is a view illustrating an example of connection between Bluetooth devices according to an example embodiment;

FIG. 12 is a signal flowchart illustrating an example of a procedure for establishing a CIS link according to an example embodiment;

FIG. 13 is a view illustrating a system structure for providing a translation service according to an example embodiment;

FIG. 14 is a flowchart illustrating a procedure of providing a translation service according to an example embodiment;

FIG. 15 is a flowchart illustrating a procedure of providing a translation service based on language identification according to an example embodiment;

FIG. 16 is a view illustrating an AI translation algorithm according to an example embodiment;

FIG. 17 is a view illustrating a translation service selection UI according to an example embodiment;

FIG. 18 is a view illustrating an operation of displaying translated text according to an example embodiment;

FIG. 19 is a view illustrating a procedure of broadcasting a translated audio according to an example embodiment;

FIG. 20 is a view illustrating broadcasting a translated audio according to an example embodiment;

FIGS. 21A, 21B, and 21C are views illustrating a UI for selecting a translation service through a Bluetooth setting according to an example embodiment;

FIGS. 22A, 22B, and 22C are views illustrating a UI for selecting a translation service through a device setting according to an example embodiment(s);

FIG. 23 is a flowchart illustrating a procedure for providing a translation service based on caching of translated data according to an embodiment; and

FIGS. 24A and 24B are views illustrating a UI of a translation service utilizing cached data according to an embodiment of the disclosure.

### DETAILED DESCRIPTION

Hereinafter, example embodiments are described with reference to the accompanying drawings. When determined to make the subject matter of the disclosure unclear, the detailed description of the related functions or configurations in the example embodiments may be skipped. The terms described below are indicated considering the functions in example embodiments and may be replaced with other terms according to the intention or practice of the user or operator. Therefore, the terms should be viewed based on the overall disclosure.

The terms as used herein are provided merely to describe an embodiment thereof, but not to limit the disclosure. The terms as used herein are provided merely to describe some embodiments thereof, but not to limit the scope of other example embodiments. Unless otherwise defined, all terms including technical and scientific terms used herein have the same meaning as commonly understood by one of ordinary skill in the art to which the example embodiments pertain and should not be interpreted as overly broad or narrow. Alternatively, the technical terms used in the disclosure may be replaced with other technical terms understandable to one of ordinary skill in the art. General terms as used herein should be interpreted in the context of the specification or as defined in dictionaries.

As used herein, the singular forms “a,” “an,” and “the” may include the plural forms as well, unless the context clearly indicates otherwise. As used herein, the term “comprise” or “include” should not be interpreted as necessarily including all of several components or operations set forth herein but should rather be interpreted as omitting some components or operations or adding more components or operations.

As used herein, the terms “first” and “second” may be used to describe various components, but the components should not be limited by the terms. The terms are used only to distinguish one component from another. For example, a first component may be denoted a second component, and vice versa without departing from the scope of the disclosure.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween. Thus, for example, “connected” as used herein covers both direct and indirect connections.

Hereinafter, example embodiments will be described in detail with reference to the accompanying drawings. The same reference denotations may be used to refer to the same or substantially the same elements throughout the specification and the drawings. No duplicate description of the same elements is given herein. When determined to make the subject matter of the disclosure unclear, the detailed description of the known art or functions may be skipped. The accompanying drawings are provided for an easier understanding of example embodiments but the disclosure should not be limited thereby. It should be interpreted that the disclosure may encompasses all other changes, equivalents, or replacements of those shown in the drawings.

In the disclosure, embodiments are described by taking an electronic device as an example, but the electronic device may also be referred to as a terminal, mobile station, mobile equipment (ME), user equipment (UE), user terminal (UT), subscriber station (SS), wireless device, handheld device, or access terminal (AT). In example embodiments, the electronic device may be, e.g., a device having communication functionality, such as a mobile phone, a personal digital assistant (PDA), a smart phone, a wireless modem, or a laptop computer.

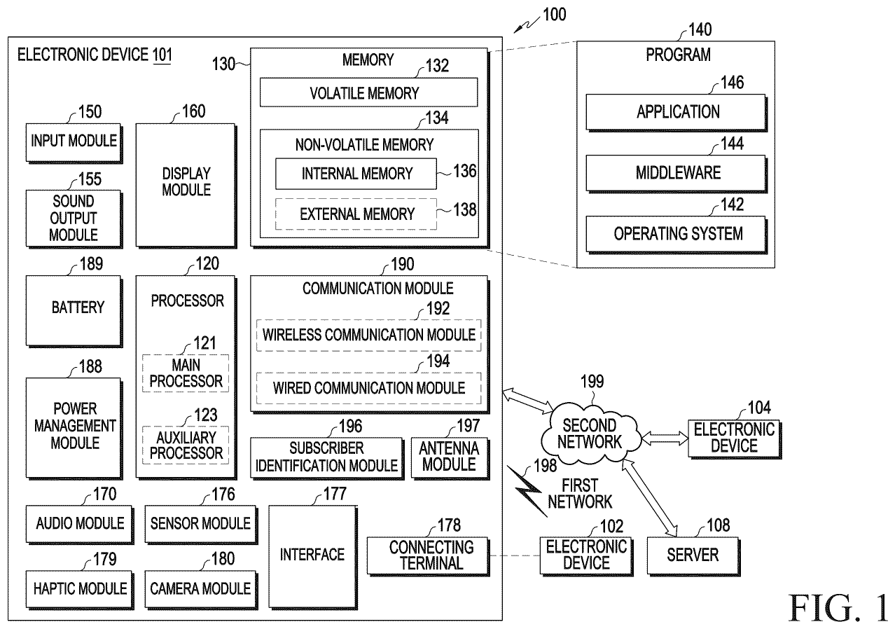

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

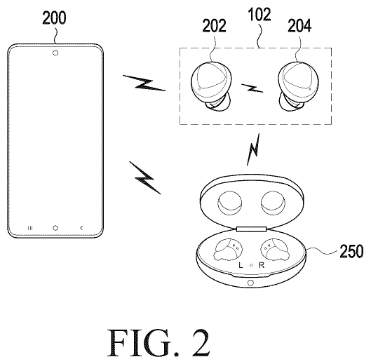

FIG. 2 is a view illustrating connection between electronic devices based on short-range wireless communication according to an example embodiment.

Referring to FIG. 2, an electronic device 200 (e.g., the electronic device 101) may be wirelessly connected to an external electronic device 102 (e.g., an ear-wearable device (ear-wearable device)). The electronic device 200 may be illustrated as, e.g., a smart phone but, without limited to those described and/or shown, may be implemented as various types of devices (e.g., notebook computers including standard laptop computers, Ultrabooks, or tab books, laptop computers, tablet computers, or desktop computers). In an embodiment, the electronic device 200 may be implemented as shown in FIG. 1 and may thus include at least some of the components (e.g., various modules) shown in FIG. 1, and no duplicate description thereof is thus given below.

In an embodiment, the external electronic device 102 is a true wireless stereo (TWS) device, such as a binaural ear-wearable device, and may include at least one of a first electronic device 202 (e.g., a right earbud) and a second electronic device 204 (e.g., a left earbud). The electronic devices 202 and 204 may be implemented as wireless earbuds but, without limited to those described and/or shown, may be implemented as various types of devices (e.g., a smart watch, a head-mounted display device, or devices for measuring biometric signals (e.g., heartrate patch)) that supports an audio service as described below. According to an embodiment, when the electronic devices 202 and 204 are wireless earbuds, the first electronic device 202 and the second electronic device 204 may be a pair of devices (e.g., a right earbud and a left earbud). According to an embodiment, the first electronic device 202 and the second electronic device 204 may be implemented to include the same or similar components.

In an embodiment, the first electronic device 202 and the second electronic device 204 are shown as a pair of earbuds, but the first electronic device 202 and the second electronic device 204 may include devices operable as a pair or electronic devices (e.g., multi-channel speaker devices) operable as one combination. According to an embodiment, the first electronic device 202 and the second electronic device 204 may be implemented to include the same or similar components to each other.

According to an embodiment, the electronic device 200 may establish at least one of a first communication link or a second communication link with at least one of a first electronic device 202 or a second electronic device 204, respectively, and transmit and/or receive data (e.g., audio and/or control information) through at least one of the first communication link or the second communication link. In an embodiment, the first communication link and/or the second communication link may include a Bluetooth-based asynchronous connection-less (ACL) link.

In an embodiment, the electronic device 200 may establish at least one communication link (e.g., the first communication link or the second communication link) with at least one of the first electronic device 202 and the second electronic device 204 based on short-range wireless communication technology, such as at least one of Wi-Fi, Wi-Fi direct, or Bluetooth (e.g., Bluetooth classic or Bluetooth low energy (BLE)), or ultra-wideband (UWB). However, the scheme in which the electronic device 200 establishes a communication link with the first electronic device 202 and the second electronic device 204 is not limited to at least one of Wi-Fi, Bluetooth, or UWB.

In an embodiment, each of the electronic devices 202 and 204 may use device-to-device (D2D) communication, such as Wi-Fi direct or Bluetooth, (e.g., using a communication circuit (e.g., the communication circuitry 320) supporting the corresponding communication scheme) to establish a communication connection with the electronic device 200 but, without limited thereto, may communicate with each other using other various types of communication (e.g., at least one of Wi-Fi communication using access points (APs), cellular communication using base stations, or wired communication).

In an embodiment, the electronic device 200 may establish a communication link with only one of the first electronic device 202 or the second electronic device 204 or establish individual communication links (e.g., the first communication link and the second communication link) with the first electronic device 202 and the second electronic device 204, respectively.

In an embodiment, the electronic device 200 may play a role as central, and the external electronic device 102 (e.g., at least one of the first electronic device 202 or the second electronic device 204) may play a role as peripheral. In an audio service, the electronic device 200 operating as central may be a source electronic device, and the external electronic device 102 (e.g., the first electronic device 202 or the second electronic device 204) operating as peripheral may be a sink electronic device.

In an embodiment, the first electronic device 202 and the second electronic device 204 may establish a communication link (e.g., a bridge communication link) therebetween based on at least one of, e.g., Wi-Fi, Bluetooth, or UWB, but the scheme for establishing a communication link by the first electronic device 202 and the second electronic device 204 is not limited to at least one of Wi-Fi, Bluetooth, or UWB.

In an embodiment, either the first electronic device 202 or the second electronic device 204 may operate as a primary device, and the other one may operate as a secondary device. The electronic device (e.g., the first electronic device 202) operating as primary may transmit data (e.g., reception acknowledgment signal or relay data) to the electronic device (e.g., the second electronic device 204) operating as secondary. For example, when the first electronic device 202 and the second electronic device 204 establish a communication link with each other, any one of the first electronic device 202 and the second electronic device 204 may be selected as primary, and the other may be selected as secondary.

In an embodiment, when the first electronic device 202 and the second electronic device 204 establish a communication connection therebetween, the device detected as first worn (e.g., when a value indicating wearing is detected by a wearing detection sensor (e.g., a proximity sensor, a touch sensor, a slope 6-axis sensor, or a 9-axis sensor)) may be selected as the primary device, and the other as the secondary device.

In an embodiment, the primary device (e.g., the first electronic device 202) may transmit data received from the external electronic device (e.g., the electronic device 200) to the secondary device (e.g., the second electronic device 204). For example, the first electronic device 202, which is the primary device, may not only output audio to the speaker 354 based on audio data received from the electronic device 200, but also output the audio data or control data (e.g., connection information) related to the audio data to the second electronic device which is the secondary device. In an embodiment, the second electronic device 204 which is the secondary device may receive the audio data, transmitted from the electronic device 200 to the primary device (e.g., the first electronic device 202), based on the connection information provided from the primary device (e.g., the first electronic device 202).

In an embodiment, the electronic device 200, the first electronic device 202, and/or the second electronic device 204 may communicate directly or indirectly with the external electronic device 250. In an embodiment, the external electronic device 250 may be an ear buds case device or cradle device for storing and charging the first electronic device 202 and the second electronic device 204. In an embodiment, the external electronic device 250 may include at least one input means (e.g., a touch panel) and/or at least one output means (e.g., a light emitting diode (LED) and/or a display) that may be used to control the operation (e.g., a pairing operation) of the external electronic device 250 or TWS electronic devices 202 and 204.

According to an embodiment, the external electronic device 250 may establish a connection (e.g., a communication link) with at least one of the electronic device 200, the first electronic device 202 or the second electronic device 204 and transmit and/or receive data to/from each other. For example, the external electronic device 250 may communicate with at least one of the electronic device 200, the first electronic device 202, or the second electronic device 204 based on at least one of power-line communication (PLC) wireless connection, Wi-Fi, Bluetooth (e.g., Bluetooth classic or Bluetooth low energy (BLE)) or UWB, but the communication scheme in which the external electronic device 250 communicates with the electronic device 200, the first electronic device 202, or the second electronic device 024 is not limited to at least one of the PLC wireless connection, Wi-Fi, Bluetooth, or UWB.

In an embodiment, the first electronic device 202 and/or the second electronic device 204 may generate an advertising signal in a multicast manner or a broadcast manner so that a peripheral electronic device (e.g., the electronic device 200) may discover the first electronic device 202 and/or the second electronic device 204. The advertising signal may include a signal for connecting to an unspecified peripheral electronic device (e.g., electronic device 200) or transmitting information related to an account using wireless communication technology (e.g., BLE). For example, the first electronic device 202 and/or the second electronic device 204 may be stored in a case (e.g., the external electronic device 250), and may be configured to generate an advertising signal when the first electronic device 202 and/or the second electronic device 204 detect that the case is opened while being stored in the case.

In an embodiment, the advertising signal may include at least one of device identification information, user account information, information (e.g., current pairing information) about whether the first electronic device 202 and/or the second electronic device 204 are currently paired with another device (not shown), a list of previously paired devices (e.g., a pairing list), information about devices simultaneously pairable (e.g., simultaneous pairing information), transmission power information, information about the detection area or remaining battery (e.g., battery status information), or audio channel role (e.g., left or right) information.

The first electronic device 202 and/or the second electronic device 204 may generate an advertising signal according to a designated condition. In an embodiment, the first electronic device 202 and/or the second electronic device 204 may start transmitting the advertising signal based on at least one of power supply, a designated time period, user input, or case opening.

When the electronic device 200 discovers the first electronic device 202 and/or the second electronic device 204 based on the advertising signal from the first electronic device 202 and/or the second electronic device 204, the electronic device 101 may output (e.g., display) a user interface for connection with the first electronic device 202 and/or the second electronic device 204. The electronic device 200 may output the user interface based on the discovery of the first electronic device 202 and/or the second electronic device 204. For example, the user interface may include a device image corresponding to the discovered external electronic device (e.g., the first electronic device 202 and/or second electronic device 204). The electronic device 200 may establish a connection (e.g., a communication link) with the first electronic device 202 and/or the second electronic device 204 based on a user input through the user interface.

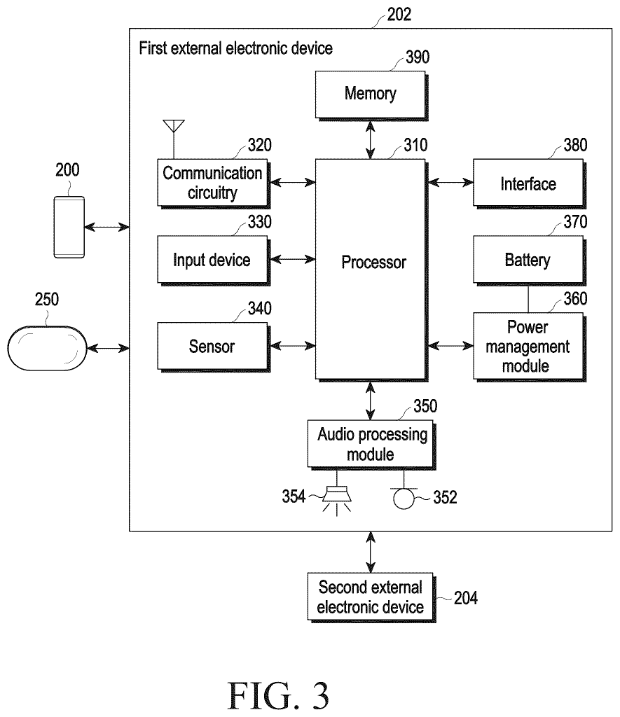

FIG. 3 is a view illustrating a configuration of an electronic device supporting short-range wireless communication according to an embodiment.

Referring to FIG. 3, the first electronic device 202 may include the same or similar components to at least one of the components (e.g., modules) of the electronic device 101 illustrated in FIG. 1. The first electronic device 202 may include at least one of a processor 310 (e.g., the processor 120 of FIG. 1), communication circuitry 320 (e.g., the communication module 190 of FIG. 1), an input device 330 (e.g., the input module 150 of FIG. 1), a sensor 340 (e.g., the sensor module 176 of FIG. 1), an audio processing module 350 (e.g., the audio module 170 of FIG. 1), a microphone 352 (e.g., the input module 150 of FIG. 1), a speaker 354 (e.g., the sound output module 155 of FIG. 1), a power management module 360 (e.g., the power management module 188 of FIG. 1), a battery 370 (e.g., the battery 189 of FIG. 1), an interface 380 (e.g., the interface 177 of FIG. 1), or memory 390 (e.g., the memory 130 of FIG. 1).

The communication circuitry 320 may include at least one of a wireless communication module (e.g., a Bluetooth communication module, a cellular communication module, a wireless-fidelity (Wi-Fi) communication module, a near-field communication (NFC) communication module, or a global navigation satellite system (GNSS) communication module) or a wired communication module (e.g., a local area network (LAN) communication module or a power line communication (PLC) communication module). As an example, the Bluetooth communication module may support at least one communication connection (e.g., communication link) by Bluetooth legacy communication (e.g., Bluetooth classic) and/or Bluetooth low energy (BLE) communication.

The communication circuitry 320 may directly or indirectly communicate with at least one of the electronic device 200 (e.g., a smartphone), the external electronic device 250 (e.g., a charging device, such as a cradle), or the second electronic device 204 (e.g., the secondary earbud) through a first network (e.g., the first network 198 of FIG. 1), using at least one communication module. The second electronic device 204 may be configured in pair with the first electronic device 202. The communication circuitry 320 may include a transmission circuit and a reception circuit configured to support communication with the electronic device 200 and/or the external electronic device 250. The communication circuitry 320 may include one or more communication processors that are operable independently from the processor 310 and supports wired or wireless communication.

The communication circuitry 320 may be connected, directly or indirectly, with one or more antennas for transmitting signals or information to another electronic device (e.g., the electronic device 200, the second electronic device 204, or the external electronic device 250) or receiving signals or information from the other electronic device. According to an embodiment, at least one antenna appropriate for a communication scheme used in a communication network, such as the first network (e.g., the first network 198 of FIG. 1) or the second network (e.g., the second network 199 of FIG. 2), may be selected from the plurality of antennas by, e.g., the communication circuitry 320. The signal or information may then be transmitted or received between the communication circuitry 320 and another electronic device via the selected at least one antenna.

The input device 330 may be configured to generate various input signals that may be used for operation of the first electronic device 202. The input device 330 may include at least one of a touch pad, a touch panel, or a button.

The input device 330 may generate a user input regarding the turn-on/off of the first electronic device 202. According to an embodiment, the input device 330 may receive a user input for a communication connection between the first electronic device 202 and the second electronic device 204. According to an embodiment, the input device 330 may receive a user input associated with audio data (or audio content). For example, the user input may be associated with functions of starting playback of audio data, pausing playback, stopping playback, adjusting playback speed, adjusting playback volume, or muting.

The sensor 340 may measure or identify the position or operational state of the first electronic device 202. The sensor 340 may convert measured or identified information into an electric signal and provide the same to the processor 310. The sensor 340 may include at least one of, e.g., a magnetic sensor, an acceleration sensor, a gyro sensor, a geomagnetic sensor, a proximity sensor, a gesture sensor, a grip sensor, a biometric sensor, or an optical sensor.

The processor 310 may detect data (e.g., audio data) from the data packets (e.g., data protocol data units (PDUs)) received from the electronic device 200 and may process the detected data through the audio processing module 350 and output it to the speaker 354. The audio processing module 350 may support an audio data gathering function and reproduce the gathered audio data.

The audio processing module 350 may include an audio decoder (not shown) and a digital-to-analog (D/A) converter (not shown). The audio decoder may convert audio data stored in the memory 390 or received from the electronic device 200 through the communication circuitry 320 into a digital audio signal. The D/A converter may convert the digital audio signal converted by the audio decoder into an analog audio signal. The audio decoder may convert audio data received from the electronic device 200 through the communication circuitry 320 and stored in the memory 390 into a digital audio signal. The speaker 354 may output the analog audio signal converted by the D/A converter.

The audio processing module 350 may include an analog-to-digital (A/D) converter (not shown). The A/D converter may convert the analog audio signal transferred through the microphone 352 (hereinafter, referred to as a mic) into a digital voice signal. The mic 352 may include at least one air conduction microphone and/or at least one bone conduction microphone for detecting voice and/or sound.

The audio processing module 350 may play various audio data set in the operation of the first electronic device 202. For example, the processor 310 may be designed to detect insertion or removal of the first electronic device 202 into/from the user's ear through the sensor 340 and reproduce audio data regarding an effect sound or guide sound through the audio processing module 350. The output of the sound effect or guide sound may be omitted according to the user setting or the designer's intention.

The memory 390 may store various data used by at least one component (e.g., the processor 310 or the sensor 340) of the first electronic device 202. The data may include, e.g., software, instructions executable by the processor 310, and input data or output data related thereto. In an embodiment, the memory 390 may include volatile memory and/or non-volatile memory.

The power management module 360 may manage power supplied to the first electronic device 202. According to an embodiment, the power management module 360 may be implemented as at least part of, for example, a power management integrated circuit (PMIC). According to an embodiment, the power management module 360 may include a battery charging module. According to an embodiment, when another electronic device (e.g., the external electronic device 250) is electrically connected (wirelessly or wiredly) with the first electronic device 202, the power management module 360 may receive power from the another electronic device to charge the battery 370.

The battery 370 may supply power to at least one component of the first electronic device 202. The battery 370 may include, e.g., a rechargeable battery. According to an embodiment, if the first electronic device 202 is mounted in the cradle device (e.g., the third electronic device 250), the first electronic device 202 may charge the battery 370 to a designated charging level and then power on the first electronic device 202 or turn on at least a portion of the communication circuitry 320.

The interface 380 may support one or more designated protocols that may be used for the first electronic device 202 to directly (e.g., wiredly) connect to the electronic device 200, the second electronic device 204, the external electronic device 250, or another external electronic device. The interface 380 may include at least one of, e.g., a high definition multimedia interface (HDMI), a USB interface, an SD card interface, a power line communication (PLC) interface, or an audio interface. According to an embodiment, the interface 380 may include at least one connection port for establishing a physical connection with the cradle device (e.g., the external electronic device 250).

The processor 310 may execute instructions and/or software to control at least one other component (e.g., a hardware or software component) of the first electronic device 202 connected, directly or indirectly, with the processor 310 and may perform various data processing or computations. According to an embodiment, as at least part of the data processing or computation, the processor 310 may load a command or data received from another component (e.g., the sensor 340 or communication circuitry 320) onto the memory 390 (e.g., volatile memory), process the command or the data stored in the memory 390 (e.g., volatile memory), and store resulting data in the memory 390 (e.g., non-volatile memory).

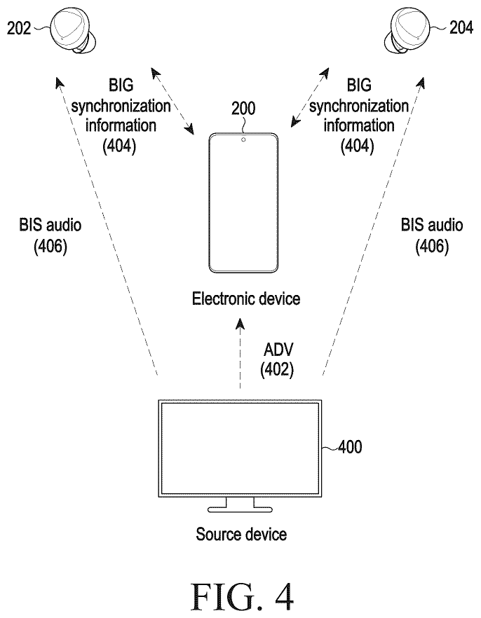

The processor 310 may receive data (e.g., broadcast audio data) from the electronic device 200 and/or external electronic device (not shown) (e.g., the source electronic device of FIG. 4) through the communication circuitry 320. The processor 310 may output the data received from the electronic device 200 through the communication circuitry 320 to the speaker 354 through the audio processing module 350. The processor 310 may transmit the data, received from the electronic device 200 through the communication circuitry 320, to the second electronic device 204 through the communication circuitry 320. The processor 310 may perform the operations of the first electronic device 202 according to example embodiments. The processor 310 may include a physical layer, a link layer, a host, and an application layer for performing Bluetooth communication.

The memory 390 may store instructions that, when executed by processor 310, enable the first electronic device 202 to operate according to example embodiments. The memory 390 may store control information and/or data necessary for the operation of the first electronic device 202 under the control of processor 310.

According to example embodiments, the first electronic device 202 may further include various circuits and/or modules depending on the form in which it is provided. There are many variations according to the convergence trend of digital devices, so it is not possible to list them all, but components equivalent to the above-mentioned components may be further included in the first electronic device 202. Further, it is apparent that in the first electronic device 202 according to various embodiments, specific components may be excluded from the above components or replaced with other components according to the form in which it is provided. This will be easily understood by those of ordinary skill in the art.

According to an embodiment, the second electronic device 204 configured in pair with the first electronic device 202 may include the same or similar components as those included in the first electronic device 202 and may perform all or some of the operations of the first electronic device 202 described below in connection with the drawings.

The BLE communication link may include at least one of a plurality of physical channels, e.g., an LE piconet physical channel, an LE advertising physical channel, an advertising periodic physical channel, and an LE isochronous physical channel, which may be optimized and used for their different purposes. The LE piconet physical channel may be used for communication between the connected devices and be connected with a specific piconet. The LE advertising physical channel may be used to broadcast advertising (advertisements) to the Bluetooth device. The advertising may be used to discover user data, connect, or send user data to the counterpart electronic device. The advertising periodical physical channel may be used to transmit user data to the counterpart electronic device 101 at specific intervals through periodic advertising. The LE isochronous physical channel may be used to transfer isochronous data between Bluetooth devices in an LE piconet, or to transfer isochronous data between unconnected Bluetooth devices.

An electronic device (e.g., the electronic device 200, the first electronic device 202, or the second electronic device 204) having a Bluetooth core version of 5.2 or higher may support an audio service through a connected isochronous stream (CIS) scheme and/or a broadcast isochronous stream (BIS) based on Bluetooth communication technology.

CIS may refer to logical transport that allows a Bluetooth device (e.g., the electronic device 200, the first electronic device 202, or the second electronic device 204) to transmit isochronous data in any direction. CIS may carry data (e.g., CIS data packets) of a fixed or variable size, and each CIS link may be associated with an asynchronous connection-less (ACL) link. The CIS link may support transmission of variable-sized packets and one or more packets in each isochronous event, and may support a variety of data rates. Data traffic on the CIS link may be unidirectional or bidirectional, and an acknowledgment protocol may be used to enhance the reliability of data transfer on the CIS link.

BIS may refer to logical transport used to transmit one or more isochronous data streams to all devices (e.g., the electronic device 200, the first electronic device 202, or the second electronic device 204) for BIS within a specified range. The BIS may include one or more subevents for transmitting isochronous data packets (e.g., BIS data packets). The BIS may support transmission of several new isochronous data packets in all BIS events. The BIS does not include an acknowledgment protocol, and may be transmitted unidirectionally from a broadcasting device (e.g., the source electronic device 400 of FIG. 4) that broadcasts traffic.

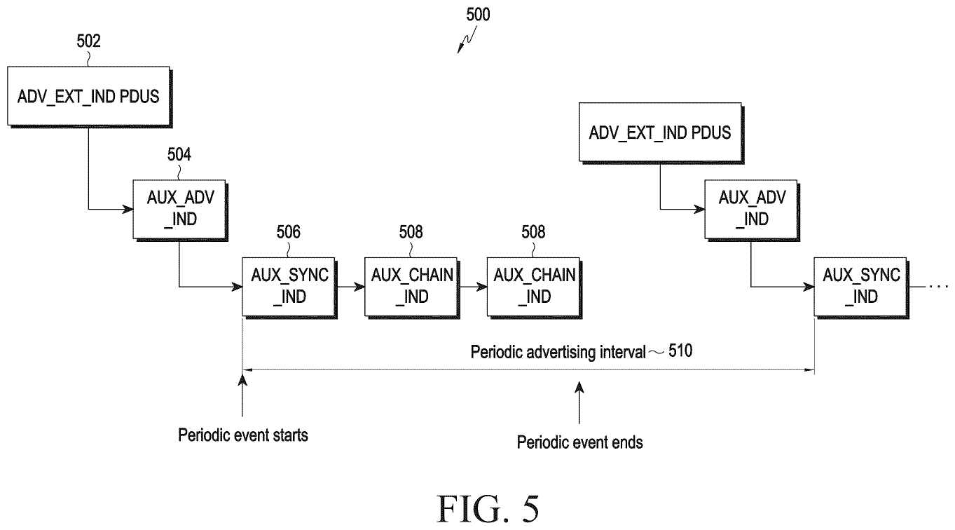

To enhance reliability of BIS logical transmission, isochronous data packets may be unconditionally retransmitted by increasing the number of subevents in all events. Transmission reliability may be enhanced by transmitting the isochronous data packets at an interval preceding an interval related to the isochronous data packets. This is referred to as pre-transmission. The BIS may be identified by a unique access address and timing information. The access address and timing information may be transmitted through advertising data (e.g., the AUX_SYNC_IND packet 506 of FIG. 5) transmitted using a corresponding periodic advertising broadcast logical transmission.

A scanning device (e.g., the a sink device) supporting a synchronized receiver role (e.g., a sink role) may receive isochronous data (e.g., isochronous data packets) from the BIS after synchronizing with the BIS using the timing information obtained from periodic advertising data (e.g., the AUX_SYNC_IND packet 506). In an embodiment, at least one of the electronic device 200, the first electronic device 202 or the second electronic device 204 may act as a sink for the source electronic device (e.g., the source electronic device 400 of FIG. 4).

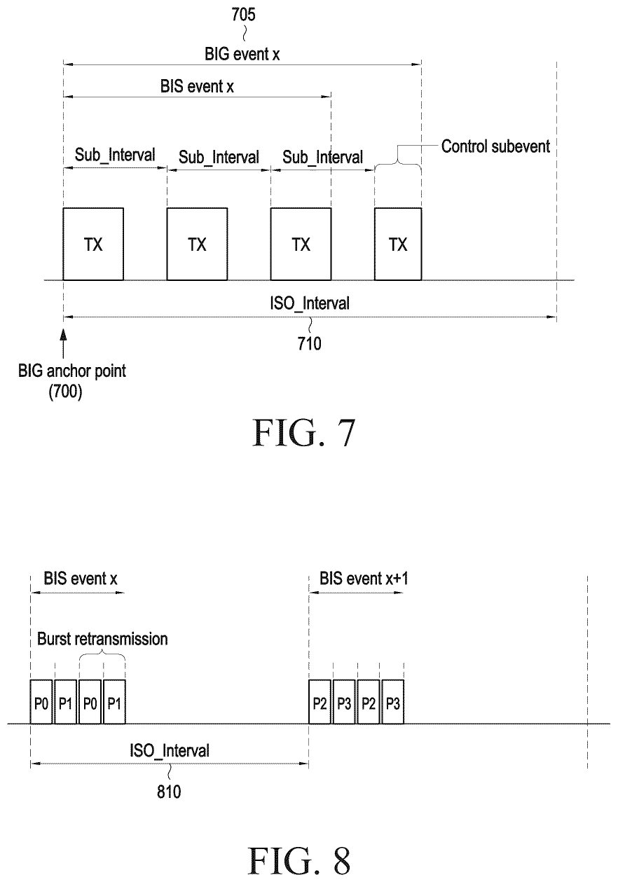

Each BIS may be part of a broadcast isochronous group (BIG). The BIG may include one or more BISs having the same isochronous interval (e.g., ISO_Interval 710 of FIG. 7). BISs in the BIG have a common timing reference based on the source electronic device (e.g., the source electronic device 400 of FIG. 4), and may be temporally synchronized with each other. The maximum number of BISs in the BIG may have a designated value (e.g., 31). BIG may also include control subevents.

FIG. 4 is a view illustrating a BIS assistant role according to an example embodiment.

Referring to FIG. 4, the electronic device 200 may connect a communication link (e.g., the first communication link and/or second communication link) with an external electronic device (e.g., the first electronic device 202 and/or second electronic device 204) that operates as a BIS sink to the source electronic device 400 that provides BIS services. In an embodiment, the electronic device 200 may discover the presence of the first electronic device 202 and/or the second electronic device 204 using wireless communication technology (e.g., BLE, Wi-Fi, and/or UWB) and connect a communication link with the first electronic device 202 and/or the second electronic device 204.

In an embodiment, the source electronic device 400 may generate a BIG including one or more BISs and broadcast advertising data 402 (e.g., at least one advertising packet) related to the BIG. For BIS synchronization, at least one of the electronic device 200, the first electronic device 202, and the second electronic device 204 may start a BLE scan. In an embodiment, the BLE scan may include an operation of monitoring reception of at least one advertising packet based on the BLE.

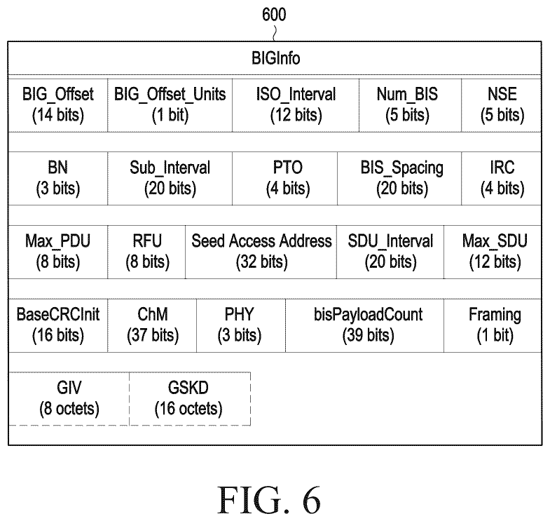

In an embodiment, the advertising data 402 broadcast by the source electronic device 400 may include extended advertising (EA) data and/or periodic advertising (PA) data. In an embodiment, the EA data may include an ADV_EXT_IND packet (e.g., ADV_EXT_IND 502 of FIG. 5) and/or an AUX_ADV_IND packet (e.g., AUX_ADV_IND 504 of FIG. 5). In an embodiment, the AUX_ADV_IND packet 504 may include audio control information (e.g., BIG parameters) necessary to receive PA data. The PA data may include an AUX_SYNC_IND packet (e.g., AUX_SYNC_IND 506 of FIG. 5) and/or at least one AUX_CHAIN_IND packet (e.g., AUX_CHAIN_IND 508 of FIG. 5). In an embodiment, the AUX_SYNC_IND packet may include BIG parameters (e.g., the BIG information 600 of FIG. 6) in, e.g., the additional controller advertising data (ACAD) field. The BIG parameters may be used for the sink device (e.g., the first electronic device 202 or the second electronic device 204) to synchronize with the BIG (e.g., at least one BIS) provided by the source electronic device 400 and receive the BIS audio data 406.

In an embodiment, the electronic device 200 may play a BIS assistant role for the first electronic device 202 or the second electronic device 204 and transfer audio control information (e.g., BIG parameters) which is at least part of the advertising data 402 received from the source electronic device 400 to the first electronic device 202 or the second electronic device 204 through the first communication link or the second communication link, respectively.

In an embodiment, the electronic device 200 may receive advertising data 402 (e.g., EA and/or PA data required to receive BIG parameters) from the source electronic device 400 through the BLE scan (e.g., a BIS scan). In an embodiment, the electronic device 202 may display a search result user interface (UI) indicating that BIS synchronization for the source electronic device 400 is possible based on receiving the EA data and receive a user input requesting to start receiving a BIS service through the search result UI. The electronic device 202 may transfer BIG synchronization information 404 including at least some parameters necessary for BIG synchronization among audio control information (e.g., BIG parameters) obtained from the EA data based on the user input to the first electronic device 202 and/or the second electronic device 204 through the first communication link and/or the second communication link. In an embodiment, the electronic device 200 may receive PA data by performing a PA scan based on the EA data received from the source electronic device 400, and display broadcast service information obtained from the PA data.

In an embodiment, instead of performing a BLE scan (e.g., a BIS scan), the first electronic device 202 or the second electronic device 204 may receive the BIS audio data 406 broadcast from the source electronic device 400 based on the BIG synchronization information 404 received from the electronic device 200 acting as the BIS assistant. In an embodiment, the first electronic device 202 or the second electronic device 204 may directly receive the advertising data 402 from the source electronic device 400 through the BLE scan and obtain information (e.g., BIG synchronization information 404) for synchronization of the BIS service from the advertising data 402. In an embodiment, the first electronic device 202 or the second electronic device 204 may receive PA data from the source electronic device 400 based on the BIG synchronization information 404, and obtain BIG parameters (e.g., BIG information 600) from the PA data.

In an embodiment, the first electronic device 202 or the second electronic device 204 may synchronize with the BIG (e.g., at least one BIS) of the source electronic device 400 based on the BIG parameters. In an embodiment, the BIG synchronization operation performed by the sink device may include an operation of calculating an access address and timing information when the BIS audio data 406 is transmitted using the BIG parameters. In an embodiment, the timing information may indicate channel information (e.g., a channel map) related to BIG and transmission time points of audio data.

In an embodiment, the first electronic device 202 or the second electronic device 204 may receive BIS audio data 406 (e.g., BIS data packets) broadcast by the source electronic device 400 through the synchronized at least one BIS. The first electronic device 202 or the second electronic device 204 may continuously receive the BIS audio data 406 broadcast by the source electronic device 400 while being synchronized with the at least one BIS.

FIG. 5 is a view illustrating Bluetooth LE (BLE) advertising according to an example embodiment.

Referring to FIG. 5, the periodic advertising train 500 may be used for the transmission of extended advertising (EA) data such as ADV_EXT_IND packet 502 and/or AUX_ADV_IND packet 504, and periodic advertising (PA) data such as AUX_SYNC_IND packet 506 and/or at least one AUX_CHAIN_IND packet 508.

The ADV_EXT_IND packet 502 is transmitted through public channels (e.g., advertising channel index Adv_idx=37, 38, and 39) and may include information (e.g., the AuxPtr field) indicating the transmission point and channel map of the AUX_ADV_IND packet 504. The AUX_ADV_IND packet 504 is transmitted according to a specific channel map (e.g., secondary advertising channel index SAdv_idx=x) identified by the ADV_EXT_IND packet 502 and may include information (e.g., BIG synchronization information 404) indicating the location of the AUX_SYNC_IND packet 506. In an embodiment, the AUX_ADV_IND packet 504 may include at least one of an access address, a channel map, an advertising interval (e.g., a periodic advertising interval 510) associated with the AUX_SYNC_IND packet 506, clock accuracy, or a time offset from the AUX_ADV_IND packet 504 to the AUX_SYNC_IND packet 506.

In an embodiment, the electronic device (e.g., the electronic device 202, the first electronic device 202, or the second electronic device 204) may receive the AUX_SYNC_IND packet 506 based on the BIG synchronization information 404 included in the AUX_ADV_IND packet 504. The AUX_SYNC_IND packet 506 may start to be transmitted through channels (e.g., SADv_idx=y, y+1, y+2) indicated by SADv_idx at the start point of each periodic advertising interval 510. The AUX_SYNC_IND packet 506 and at least one AUX_CHAIN_IND packet 508 may be transmitted during the periodic advertising interval 510.

In an embodiment, the AUX_SYNC_IND packet 506 may include BIG parameter information (e.g., BIG information 600 of FIG. 6) related to a broadcast audio service (e.g., a BIS service). In an embodiment, the AUX_SYNC_IND packet 506 may include broadcast service information (e.g., broadcast service name, codec information, audio information, and/or appearance information) about the currently streaming BIS in the AdvData field. The sink device (e.g., the electronic device 200, the first electronic device 202, or the second electronic device 204) that has obtained the AUX_SYNC_IND packet 506 may display at least some of the broadcast service information.

In an embodiment, the sink device (e.g., the electronic device 200, the first electronic device 202, or the second electronic device 204) may obtain BIG_Offset from BIG parameter information (e.g., the BIG information 600 of FIG. 6) included in the AUX_SYNC_IND packet 506. BIG_Offset may indicate a time from the start of the AUX_SYNC_IND packet 506 including the BIG information 600 to the next BIG anchor point. The sink device (e.g., electronic device 200, first electronic device 202, or second electronic device 204) may receive BIS audio data (e.g., BIS data packets) through a BIG event (e.g., BIG event x 705 of FIG. 7) starting from the BIG anchor point.

FIG. 6 is a view illustrating BIG information including BIG parameters according to an example embodiment.

Referring to FIG. 6, the BIG information 600 may include BIG parameters, such as at least one of BIG_Offset, BIG_Offset_units, ISO_Interval, Num_BIS, number of subevent (NSE), burst number (BN), Sub_Interval, pre-transmission offset (PTO), BIS_Spacing, immediate repetition count (IRC), Max_PDU, reserved for future use (RFU), SeedAccessAddress, SDU_Interval, Max_SDU, BaseCRCInit, channel map (ChM), physical (PHY), bisPayloadCount, Framing, group initialization vector (GIV), or group session key derivation (GSKD). In an embodiment, the length of the BIG information 600 may be 33 octets when not encrypted, and 57 octets when encrypted.

BIG parameters that may be included in the BIG information 600 will be described below.

Num_BIS indicates the number of BISs in the BIG. Each of the BISs in the BIG may be assigned a different BIS_Number from 1 to Num_BIS.

ISO_Interval may indicate a time of 1.25 ms between two adjacent BIG anchor points. (e.g. 5 ms to 4 s)

BIS_Spacing may indicate the time between the start time of the subevents in adjacent BISs in the BIG and the start time of the first subevent of the last BIS.

Sub_Interval may indicate the time between start times of two consecutive subevents of each BIS.

Max_PDU is the maximum number of data octets capable of transmitting each BIS data packet within the BIG and may indicate the maximum duration of the packet. (e.g. 1 to 251 octets)

Max_SDU may indicate the maximum size (e.g., maximum duration) of the service data unit (SDU) in the BIG. (e.g. 1 to 4095 octets)

BN, PTO, and IRC may include values for controlling which data is transmitted in each BIG event. Subevents of each BIS event may be divided into groups (e.g., subevent groups) including BN subevents. Thus, the group count (GC)) is NSE/BN. IRC may designate the number of groups carrying data related to the current BIS event. The remaining groups may carry data related to future BIS events designated by the PTO.

IRC may be greater than 0 and may not be greater than GC. If IRC=GC, the PTO may be ignored, otherwise the PTO may be greater than zero. Groups of subevents may be sequentially numbered (e.g., group index g) from 0 to GC−1. When g<IRC, the group g may include data related to the current BIS event. When g>=IRC, group g may include data related to a future BIS event (e.g., PTO*(g−IRC+1)th BIS event) after the current BIS event.

The NSE indicates the maximum number of subevents within each BIG event.

The framing field may indicate whether the BIG transmits framed data or unframed data.

BIG_Offset may indicate the time from the start time of the packet (e.g., AUX_SYNC_IND of operation 516) including the BIG information 600 to the next BIG anchor point. The value of BIG_Offset may be indicated in units indicated by bits of BIG_Offset_Units. The time offset is determined by multiplying the value of BIG_Offset by the unit indicated by BIG_Offset_Units. The time offset may be greater than 600 μs (micro second). When the bit of BIG_Offset_Units is set, the unit is 300 μs, otherwise 30 μs. The bit of BIG_Offset_Units may not be set if the time offset is less than 491,460 μs. The BIG anchor point may be between the time offset and the time offset plus 1 unit after the start time of the packet (e.g., AUX_SYNC_IND) as follows.

The parameters included in the BIG information 600 may not be changed during the lifetime of the BIG.

The source electronic device 400 may transmit (e.g., broadcast) BIS audio data (e.g., BIS data packets) according to the parameters included in the BIG information 600.

FIG. 7 is a view illustrating a BIG event and a BIS event according to an example embodiment.

Referring to FIG. 7, a BIG event (e.g., the BIG event x 705) may include one or more BIS data packets (e.g., PDUs). A source electronic device (e.g., the source electronic device 400) may transmit BIS data packets (e.g., right audio data packet and left audio data packet) in each BIG event (e.g., BIG event x 705). Each BIG event (e.g., BIG event x 705) may be divided into Num_BIS BIS events and, if present, one control subevent. Each BIS event may be divided into NSE subevents.

Each BIS event may start at a BIS anchor point (e.g., the BIS anchor point 700) and end after the last subevent. Each BIG event (e.g., the BIG event x 705) may start at the BIG anchor point and, if there is a control subevent, it may end thereafter, otherwise, end at the last constituent BIS event. The BIG anchor points may be regularly spaced apart by an interval of ISO_Interval 710. The BIS anchor points for BIS n of the BIG may be after (n−1)×BIS_Spacing from the BIG anchor points, and may be regularly spaced apart by ISO_Interval 710. The subevents of each BIS may be spaced apart by Sub_Interval. The source electronic device (e.g., the source electronic device 400) may terminate the current BIG event (e.g., the BIG event x 705), at least T_IFS (time for inter frame space) (e.g., 150 μs) before the BIG anchor point of the next BIG event. The time interval between two consecutive packets on the same channel may be referred to as T_IFS. T_IFS may be the time from the end point of the last bit of the previous packet to the start point of the first bit of the subsequent packet.

BISs in the BIG may be arranged sequentially or interleaved according to Sub_Interval and BIS_Spacing. In the case of sequential arrangement, BIS_Spacing may be greater than or equal to NSE×Sub_Interval, and all subevents of the BIS event may occur together. When interleaved, Sub_Interval may be Num_BIS×BIS_Spacing, the first subevents of all BISs may be adjacent, and the second subevents of all the following BISs may be adjacent.

The maximum length possible for the data portion (except for the control subevent) of the BIG event may be indicated as BIG_Sync_Delay. The value of BIG_Sync_Delay may be the same as the time from the BIS anchor point to the BIG synchronization point, which is the end point of the packet including the payload of the Max_PDU octet transmitted in the last subevent. (BIG_Sync_Delay=(Num_BIS−1)×BIS_Spacing+(NSE−1)×Sub_Interval+MPT)

The BIS subevent is an opportunity for the source electronic device 400 to transmit BIS data packets and for the sink electronic device (e.g., the electronic device 200, the first electronic device 202 and/or the second electronic device 204) operating as a sink to receive the BIS data packets. The source electronic device 400 may transmit one BIS data packet at a time point at which each BIS subevent of the BIS event starts, and may transmit, e.g., at least one BIS packet within six consecutive BIS events.

For each BIS event, the source electronic device 400 may provide a data burst including BN payloads. Each payload may include a single fragment or one or more SDU segments. One data burst is related to a designated BIS event, but may be transmitted in earlier events.

FIGS. 8, 9, and 10 are views illustrating transmission of BIS data packets according to example embodiments.

Referring to FIG. 8, payloads may be allocated to BIS sub-events in each BIS event in a BIS having BN=2, IRC=2, PTO=0, and NSE=4. One BIS event corresponding to ISO_Interval 810 may include up to NSE (=4) BIS sub-events. BIS data packets (e.g., P0, P1, or P2, P3) each including two payloads in each BIS event (e.g., BIS event x or BIS event x+1) may be allocated to two preceding BIS sub-events, and the remaining sub-events may be used for retransmission of the same BIS data packets (e.g., P0, P1, or P2, P3).

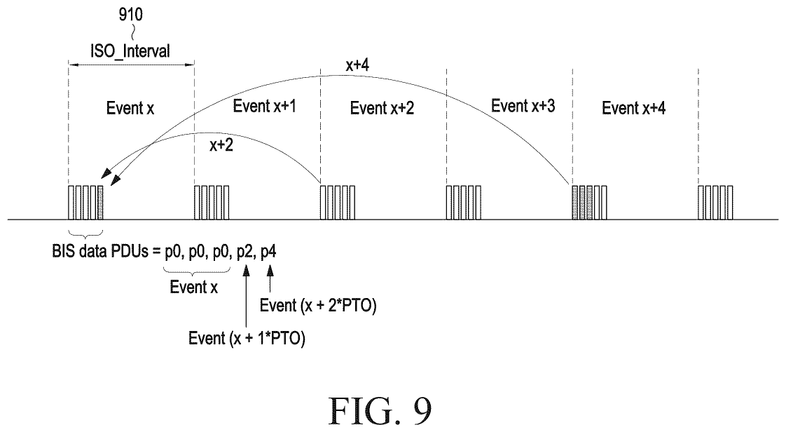

Referring to FIG. 9, payloads may be allocated to BIS sub-events in each BIS event in a BIS having BN=1, IRC=3, PTO=2, and NSE=5. One BIS event (e.g., BIS event x) corresponding to ISO_Interval 910 may include up to NSE (=5) BIS sub-events. Within the BIS event x, the BIS data packet p0 may be transmitted in three preceding BIS sub-events, the BIS data packet p2 for the BIS event x+2 may be transmitted in the fourth BIS sub-event, and the BIS data packet p4 for the BIS event x+4 may be transmitted in the last BIS sub-event. Accordingly, the BIS data packet p2 may be repeatedly transmitted in the BIS event x and the BIS event x+2, and the BIS data packet p4 may be repeatedly transmitted in the BIS event x and the BIS event x+4.

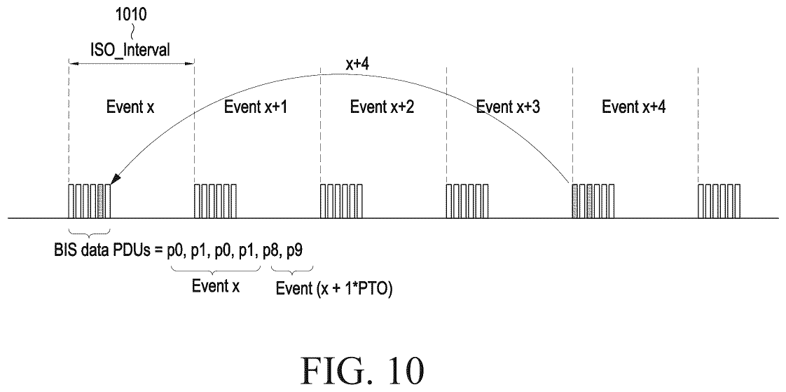

Referring to FIG. 10, payloads may be allocated to BIS sub-events in each BIS event in a BIS having BN=2, IRC=2, PTO=4, and NSE=6. One BIS event (e.g., BIS event x) corresponding to ISO_Interval 1010 may include up to NSE (=6) BIS sub-events. Within the BIS event x, the BIS data packets p0 and p1 may be transmitted in four previous BIS sub-events, and in the last two BIS sub-events, the BIS data packets p8 and p9 for the BIS event x+4 may be transmitted. Accordingly, the BIS data packets p8 and p9 may be repeatedly transmitted in the BIS event x and the BIS event x+4.

Among various Bluetooth topologies, the first electronic device 202 and the second electronic device 204 included in an ear wearable device (e.g., the electronic device 102) such as TWS may receive audio data of different channels (e.g., a left channel and a right channel) of the same audio service. For example, the second electronic device 204 may receive at least a portion of audio data received by the first electronic device 202 from an external electronic device (e.g., the electronic device 200 of FIG. 2) from the first electronic device 202. For example, in the BLE audio topology, the first electronic device 202 and the second electronic device 204 may use an audio service from an external electronic device (e.g., the electronic device 200 or the source electronic device 400).

In an embodiment, the first electronic device 202 and the second electronic device 204 may communicate with each other for various purposes, such as exchanging states with each other and/or changing operating parameters, and the communication may be referred to as bridge communication. For example, in an ear wearable device such as a TWS, each of the first electronic device 202 corresponding to the left channel and the second electronic device 204 corresponding to the right channel may obtain information about the state (e.g., a communication degradation situation, whether it is worn, whether it is stored in a case, and/or a battery status) of the counterpart electronic device through bridge communication (e.g., communication between TWSs). In an embodiment, the first electronic device 202 and the second electronic device 204 may use a fixedly limited communication time (e.g., communication time between TWSs) on a communication link for bridge communication while using an audio service on a connection basis or non-connection basis with an external electronic device (e.g., the electronic device 200 of FIG. 2).

In an embodiment, a source electronic device (e.g., the source electronic device 400) providing an audio service may transmit audio data to one or more nearby sink electronic devices (e.g., the first electronic device 202 and/or the second electronic device 204) using at least one BIS, and the sink electronic devices may simultaneously output the audio data. The source electronic device 400 may provide a broadcast audio service (e.g., a BIS service) to nearby sink electronic devices (e.g., the first electronic device 202 and/or the second electronic device 204) using the same parameters (e.g., the BIG information 600 of FIG. 6) and timing.

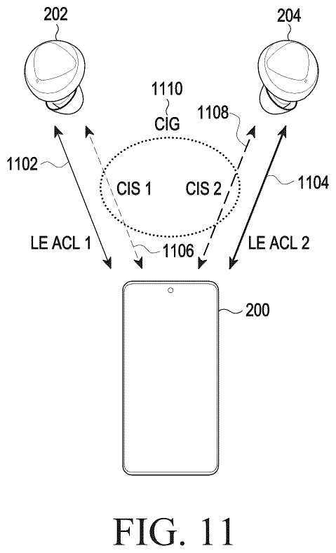

FIG. 11 is a view illustrating an example of connection between Bluetooth devices according to an example embodiment.

Referring to FIG. 11, the electronic device 200 may detect the presence of the first electronic device 202 and establish a first asynchronous connection-less (ACL) link 1102 (hereinafter, referred to as ACL1 or LE ACL1) therebetween based on BLE. The electronic device 200 may detect the presence of the second electronic device 204 and establish a second ACL link 1104 (hereinafter, referred to as ACL2 or LE ACL2) therebetween based on BLE. In an embodiment, the electronic device 200 may establish the second ACL link 1104 with the aid of the first electronic device 202.

In an embodiment, the first electronic device 202 or the second electronic device 204 may start to broadcast an advertising signal based on a designated condition (e.g., when detecting opening of the case (e.g., the external electronic device 250) while the first electronic device 202 and/or the second electronic device 204 is stored in the case, or when the first electronic device 202 and/or the second electronic device 204 is removed from the case (e.g., the external electronic device 250)).

In an embodiment, the electronic device 200 may discover the first electronic device 202 and establish a first ACL link 1102 with the first electronic device 202 by receiving the advertising signal broadcast from the first electronic device 202. In an embodiment, the electronic device 200 may discover the second electronic device 204 and establish a second ACL link 1104 with the second electronic device 204 by receiving the advertising signal broadcast from the second electronic device 204.

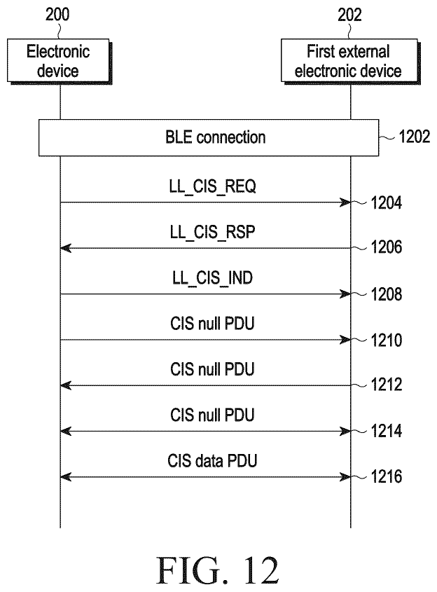

In an embodiment, the electronic device 200 may establish a first connected isochronous stream (CIS) link 1106 (hereinafter, referred to as CIS1) that uses an isochronous physical channel, using the first ACL link 1102 and exchange isochronous data (e.g., audio data) with the first external electronic device 202 through the first CIS link 1106. In an embodiment, the electronic device 200 may establish a first CIS link 1106 with the first external electronic device 202 using the procedure of FIG. 12. Similarly, the electronic device 200 may establish a second CIS link 1108 (hereinafter, referred to as CIS2) using the second ACL link 1104 and exchange isochronous data (e.g., audio data) with the second external electronic device 204 through the second CIS link 1108. In an embodiment, the electronic device 200 may establish a second CIS link 1108 with the second external electronic device 204 using the procedure of FIG. 12. The first CIS link 1106 and the second CIS link 1108 may be included in one CIS group (CIG) 1110.

In an embodiment, the first ACL link 1102 may be a logical transmission used to exchange information necessary to establish or control the first CIS link 1106 between the electronic device 200 and the first external electronic device 202. The first CIS link 1106 may be used to communicate audio data between the electronic device 200 and the first external electronic device 202. In an embodiment, the electronic device 200 and the first external electronic device 202 may establish the first CIS link 1106 based on information (e.g., communication parameters) obtained through the first ACL link 1102. In an embodiment, the electronic device 200 and the first external electronic device 202 may exchange information (e.g., supported feature information and/or PHY change policy) to be applied to the control of the first CIS link 1106, through the first ACL link 1102.

In an embodiment, the second external electronic device 204 may establish a second ACL link 1104 and a second CIS link 1108 with the electronic device 200 and may perform the same or similar operation as that of the first external electronic device 202. In an embodiment, the second external electronic device 204 may communicate with the electronic device 200 through the control of the first external electronic device 202.

In an embodiment, the first CIS link 1106 and/or the second CIS link 1108 may be maintained until the use of the first external electronic device 202 and/or the second external electronic device 204 is terminated, or until an audio output-related service (e.g., a music/movie/game application) being used in the electronic device 200 is terminated. In an embodiment, when the first external electronic device 202 and/or the second external electronic device 204 is an LE audio-enabled speaker device connected to a power source, the electronic device 200 may maintain the first CIS link 1106 and/or the second CIS link 1108 because there is no restriction on current consumption. On the other hand, when the first external electronic device 202 and/or the second external electronic device 204 is a wireless device, the electronic device 200 disconnects the first CIS link 1106 and/or the second CIS link 1108 while maintaining only the first ACL link 1102 and/or the second ACL link 1104 while there is no audio output, thereby saving power consumption of the first external electronic device 202 and/or the second external electronic device 204. When audio transmission (e.g., a translation service according to an example embodiment) is required, the electronic device 200 may reconnect the first CIS link 1106 and/or the second CIS link 1108 using the first ACL link 1102 and/or the second ACL link 1104.

FIG. 12 is a signal flowchart illustrating an example of a procedure for establishing a CIS link according to an example embodiment. Here, the establishment of a CIS link between the electronic device 200 and the first external electronic device 202 is described, but operations to be described below may also be performed between the electronic device 200 and the second external electronic device 204.

Referring to FIG. 12, in operation 1202, the electronic device (e.g., the electronic device 200) may have a BLE connection (e.g., the ACL link 1102) with an external electronic device (e.g., the first external electronic device 202). In operation 1204, the electronic device 200 may transmit a link layer (LL) CIS request message (e.g., LL_CIS_REQ packet) including control data (e.g., control data 800 of FIG. 8) for establishing a CIS link (e.g., the first CIS link 506) to the first external electronic device 202. In operation 1206, upon receiving a link layer CIS response message (e.g., LL_CIS_RSP packet) from the first external electronic device 202, the electronic device 200 may transmit a link layer CIS indication message (e.g., LL_CIS_IND packet) to the first external electronic device 202 in operation 1208.

In operations 1210, 1212, and 1214, the electronic device 200 and the first external electronic device 202 may establish a CIS link by exchanging one or more CIS null packets (e.g., protocol data unit (PDU)). In operation 1216, the electronic device 200 and the first external electronic device 202 may communicate CIS data PDUs through the CIS link.

The BIS service using LE audio is mainly used by electronic devices (e.g., TV devices or broadcast transmitters) accessible by multiple users and may be used to provide an audio service for an undesignated number of people over a long period of time. Recently, electronic devices such as TVs or mobile phones have been developed to support BIS services for the purpose of simultaneously receiving audio services by a small number of user groups rather than an undesignated number of users. However, the audio service provided by the source electronic device of the BIS service may have limitations in providing the desired information to all users due to the unidirectional nature.

As an example, the BIS service basically provides audible information, and the audio data for the BIS service may transfer information in a specific language to the BIS assistant device (e.g., electronic device 200) or sink device (e.g., first external electronic device 202 and/or second external electronic device 204). When the BIS service provides audio in a language other than the user's native language, it may be difficult for the user to understand the received audio.

For example, a TV (e.g., source electronic device 400) positioned in a public place may broadcast BIS audio data expressed in Korean through the BIS service. Americans or Japanese who do not know Korean may not understand the BIS audio data even if they receive the BIS audio data through their sink device (e.g., the first external electronic device 202 and/or the second external electronic device 204).

For example, if an in-flight broadcasting BIS service is broadcast in a designated language, such as Korean, English, Japanese, or Chinese, in an airplane where access to a public network is impossible, users of other languages may not understand the audio data of the BIS service, nor may they use a translation service based on public network access, thereby missing important safety information.

Certain example embodiments may provide a translation service for BIS audio data expressed in a language other than a language desired by the user. Certain example embodiments may translate BIS audio data broadcast from a source electronic device (e.g., source electronic device 400 of FIG. 4) acting as a BIS source into other languages by an electronic device (e.g., electronic device 200) acting as a BIS assistant. The electronic device 200 according to example embodiments may transfer audio data translated into a language desired by the user to an external electronic device (e.g., the first external electronic device 202 and/or the second external electronic device 204) connected to the electronic device 200 through a wireless communication link (e.g., the first CIS link 1106 and/or the second CIS link 1108).

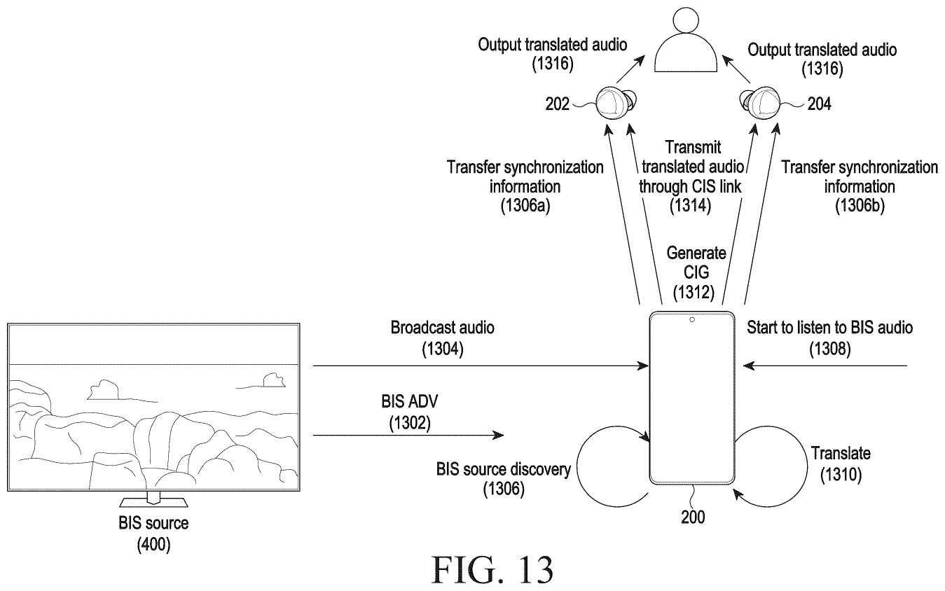

FIG. 13 is a view illustrating a system structure for providing a translation service according to an example embodiment.

Referring to FIG. 13, in operations 1302 and 1304, the source electronic device 400 configured to operate as a BIS source role may broadcast advertising (ADV) data and BIS audio data for a BIS service. In an embodiment, the advertising data may include EA data (e.g., ADV_EXT_IND 502 and/or AUX_ADV_IND 504 of FIG. 5) and PA data (e.g., AUX_SYNC_IND 506 of FIG. 5 and/or AUX_CHAIN_IND 508 of FIG. 5) related to the BIS audio data.

In operation 1306, the electronic device 200 may discover the source electronic device 400 by detecting the advertising data (e.g., ADV_EXT_IND 502 of FIG. 5) broadcast from the source electronic device 400 through a BLE scan. In operations 1306a and 1306b, the electronic device 200 may operate as a BIS assistant to transfer BIG synchronization information (e.g., at least a portion of the AUX_ADV_IND 504 and/or BIG information 600) which is at least a portion of the advertising data to an external electronic device (e.g., the first external electronic device 202 and/or the second external electronic device 204), so that the external electronic device may receive BIS audio data from the source electronic device 400 based on the BIG synchronization information. In an embodiment, the external electronic device may be earbuds (e.g., the first external electronic device 202 and the second external electronic device 204), smart glasses, a smart headset, or non-display smart glasses.

In operation 1308, the electronic device 200 may determine to provide a translation service for the external electronic device (e.g., the first external electronic device 202 and the second external electronic device 204) and may start receiving the BIS audio data based on advertising data (e.g., PA data or AUX_SYNC_IND packet 506) received from the source electronic device 400 to operate as a BIS sink.

In an embodiment, in operation 1306a and/or operation 1306b, the advertising data may receive the AUX_SYNC_IND packet 506 based on the BIG synchronization information provided by the electronic device 200 to the first external electronic device 202 and/or the second external electronic device 204 and may start receiving the BIS audio data based on the AUX_SYNC_IND packet 506. In an embodiment, the electronic device 200 may receive PA data (e.g., AUX_SYNC_IND 506) using the AUX_ADV_IND 504, obtain BIG information 600 included in the AUX_SYNC_IND 506, and start receiving the BIS audio data using the BIG information 600.

In an embodiment, the electronic device 200 may identify that the BIS audio data is represented in a first language. In an embodiment, the BIS audio may include audio data (e.g., airport announcements provided in English, Chinese, and Japanese) with the same content expressed in one or more languages, and the electronic device 200 may select and receive audio data expressed in one designated language (e.g., the first language). In an embodiment, the electronic device 200 may identify a subgroup including the audio data in the first language based on the user setting of the electronic device 200 and BIG information obtained in operation 1302 and receive the audio data in the first language through the subgroup.

In operation 1310, the electronic device 200 may translate the BIS audio data into audio data expressed in a second language. In an embodiment, the electronic device 200 may determine to provide the translation service based on identifying that the BIS audio data is represented in the first language and that the first language is different from a second language (e.g., a default language set by the electronic device 200 or a language selected by the user) designated for the translation service. In an embodiment, the electronic device 200 may determine to provide the translation service based on a user input requesting the translation service.

In operation 1312, the electronic device 200 may generate a wireless communication link (e.g., a CIG including a first CIS link 1106 and a second CIS link 1108) for audio transmission with the first external electronic device 202 and the second external electronic device 204. In an embodiment, the electronic device 200 may establish the wireless communication link at a time point when the first external electronic device 202 and the second external electronic device 204 are discovered before starting to receive the BIS audio data. In an embodiment, the electronic device 200 may establish the wireless communication link based on identifying that the electronic device 200 is not connected to the first external electronic device 202 and the second external electronic device 204 for audio transmission after determining to provide a translation service for the first external electronic device 202 and the second external electronic device 204.

In an embodiment, the first external electronic device 202 and/or the second external electronic device 204 may generate an advertising signal according to a designated condition. As an example, when powered on, the first external electronic device 202 and/or the second external electronic device 204 may start broadcasting the advertising signal according to a designated time period or in response to at least one of user inputs. The electronic device 200 may receive the advertising signal, output designated information (e.g., sound or audio) according to various conditions based on the information included in the advertising signal, or perform operations of generating an LE link (e.g., the first ACL link 1102 or the second ACL link 1104). The electronic device 200 may establish a wireless communication link (e.g., the first CIS link 1106 and the second CIS link 1108) for audio transmission with the first external electronic device 202 and/or the second external electronic device 204 using the LE link.

In operation 1314, the electronic device 200 may operate as a CIS source to transmit the translated audio data to the first external electronic device 202 and/or the second external electronic device 204 through the wireless communication link (e.g., the first CIS link 1106 and/or the second CIS link 1108). In an embodiment, the electronic device 200 may generate one or more CIS data packets including the translated audio data and transmit the CIS data packets to the first external electronic device 202 and/or the second external electronic device 204 through the wireless communication link (e.g., the first CIS link 1106 and/or the second CIS link 1108).

In an embodiment, the CIS data packets transmitted to the first CIS link 1106 may include audio data of a right channel translated from BIS audio data. The CIS data packets transmitted to the second CIS link 1108 may include audio data of the left channel translated from the BIS audio data. In an embodiment, the electronic device 200 may mix the audio data of the right channel and the audio data of the left channel translated from the BIS audio data, and transmit the mixed data to the first external electronic device 202 and the second external electronic device 204 through the first CIS link 1106 and the second CIS link 1108 in the same manner.

In an embodiment, the electronic device 200 may transmit audio data in different languages to the first external electronic device 202 and the second external electronic device 204 through the first CIS link 1106 and the second CIS link 1108. In an embodiment, the electronic device 200 may transmit audio data expressed in the first language to the first external electronic device 202 through the first CIS link 1106, and transmit audio data translated into the second language to the second external electronic device 204 through the second CIS link 1108. In an embodiment, the electronic device 200 may receive audio data expressed in the first language from the source electronic device 400 and translate the audio data in the first language into audio data in the second language and audio data in the third language. In an embodiment, the electronic device 200 may transmit audio data translated into the second language to the first external electronic device 202 through the first CIS link 1106, and transmit audio data translated into the third language to the second external electronic device 204 through the second CIS link 1108.

In an embodiment, the electronic device 200 may mix BIS audio data and translated audio data corresponding to the BIS audio data, and transmit the mixed data to the first external electronic device 202 and the second external electronic device 204 through the first CIS link 1106 and the second CIS link 1108 in the same manner. In an embodiment, the first external electronic device 202 and the second external electronic device 204 may stop receiving audio data from the source electronic device 400 and output (e.g., reproduce) the mixed data received through the first CIS link 1106 and the second CIS link 1108.

In operation 1316, the first external electronic device 202 and the second external electronic device 204 may output the translated audio data through a speaker (e.g., the speaker 354). In an embodiment, the first external electronic device 202 and the second external electronic device 204 may output the BIS audio data directly received from the source electronic device 400 through the speaker 354 while simultaneously outputting the translated audio data in synchronization with the BIS audio data. In an embodiment, at least one of the translated audio data or the BIS audio data may be decreased in volume before being output.

In an embodiment, the source electronic device 400 may be a medium (e.g., a radio broadcast device) capable of outputting audio. In an embodiment, the source electronic device 400 is a medium (e.g., TV) capable of simultaneously outputting an image and an audio, and may broadcast BIS audio data to be synchronized with the image reproduced by the source electronic device 400. As an example, the BIS audio data may include at least one of sports broadcasting, airport announcement, art museum docent, subway announcement, indoor navigation, audio announcement in public places, conference audio, seminars, or lectures. In an embodiment, the source electronic device 400 may broadcast an audio of a speaker coming out of the screen while displaying a video of a video conference through a screen. The user participating in the video conference may receive audio broadcast from the source electronic device 400 directly through an external electronic device (e.g., the first external electronic device 202 and/or the second external electronic device 204) while watching the image broadcast on the screen of the source electronic device 400, or may receive a translated audio transferred from the electronic device 200 through an external electronic device (e.g., the first external electronic device 202 and/or the second external electronic device 204).

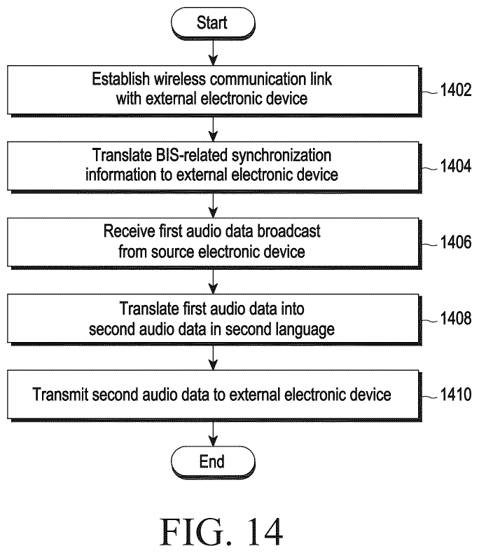

FIG. 14 is a flowchart illustrating a procedure for providing a translation service according to an example embodiment. According to embodiments, at least one of the operations to be described below may be omitted, modified, or executed in a different order. At least one of the operations described below may be executed by a processor (e.g., the processor 120 of FIG. 1) of the electronic device 200 (e.g., the electronic device 101 of FIG. 1). In an embodiment, the memory (e.g., the memory 130 of FIG. 1) of the electronic device 200 may store instructions that enable the electronic device 200 to operate according to at least one of the operations described below.

Referring to FIG. 14, in operation 1402, the electronic device 200 (e.g., the processor 120) may establish at least one wireless communication link with an external electronic device (e.g., the first external electronic device 202 and/or the second external electronic device 204) that provides an audio output function. In an embodiment, the external electronic device may be earbuds, smart glasses, or a smart headset. In an embodiment, the at least one wireless communication link may include at least one LE link (e.g., the first ACL link 1102, the second ACL link 1104, the first CIS link 1106, and/or the second CIS link 1108).

In an embodiment, the wireless communication link may include at least one CIS (e.g., the first CIS link 1106 and/or the second CIS link 1108) for audio transmission. In an embodiment, the electronic device 200 (e.g., the processor 120) may generate a CIG including the first CIS link 1106 and/or the second CIS link 1108.

In an embodiment, the at least one CIS (e.g., the first CIS link 1106 and/or the second CIS link 1108) may be generated based on the electronic device 200 discovering the first external electronic device 202 and/or the second external electronic device 204, may be generated based on the electronic device 200 determining to transmit audio to the first external electronic device 202 and/or the second external electronic device 204, or the electronic device 200 determining to provide a translation service related to a BIS service for the first external electronic device 202 and/or the second external electronic device 204.

As an example, although FIG. 14 illustrates that operation 1402 is performed before operation 1404, in an embodiment, operation 1402 of establishing the wireless communication link may be performed at any time point before operation 1410. In an embodiment, the electronic device 200 (e.g., the processor 120) may reconnect the first CIS link 1106 and/or the second CIS link 1108 based on determining to start the translation service according to an example embodiment in a state in which the first CIS link 1106 and/or the second CIS link 1108 is released. In an embodiment, the first CIS link 1106 and/or the second CIS link 1108 may be established by exchanging messages (e.g., LL_CIS_REQ, LL_CIS_RSP, and/or CIS_IND of FIG. 12) related to a service connection through the first ACL link 1102 and/or the second ACL link 1104.

In operation 1404, the electronic device 200 (e.g., the processor 120) may receive synchronization information (e.g., at least a portion of the AUX_ADV_IND packet 504 or BIG information 600) broadcast from the source electronic device 400 providing the BIS service, and transmit the synchronization information to the external electronic device (e.g., the first external electronic device 202 and/or the second external electronic device 204). In an embodiment, the synchronization information may be transferred through a wireless communication link (e.g., the first ACL link 1102 or the second ACL link 1104) connected between the electronic device 200 and the external electronic device.

In an embodiment, the external electronic device (e.g., the first external electronic device 202 and/or the second external electronic device 204) may receive audio data (e.g., BIS data packets) broadcast from the source electronic device 400 and output (e.g., reproduce) the audio data by synchronizing with the BIS service from the source electronic device 400 based on the synchronization information. In an embodiment, the external electronic device may receive PA data (e.g., the AUX_SYNC_IND packet 506) based on the synchronization information, and receive the audio data from the source electronic device 400 using BIG information (e.g., BIG information 600 of FIG. 6) obtained from the PA data.

In an embodiment, the electronic device 200 (e.g., the processor 120) may discover the source electronic device 400 by receiving EA data (e.g., ADV_EXT_IND packet 502 and/or AUX_ADV_IND packet 504) broadcast from the source electronic device 400 based on determining to act as an assistant for the BIS service, receive PA data (e.g., AUX_SYNC_IND packet 506) from the source electronic device 400 based on the EA data, and display brief information (e.g., device name and/or broadcast service name) related to the BIS service provided by the source electronic device 400 based on the PA data. Based on receiving a user input for selecting to receive the BIS service after displaying the information, the electronic device 200 (e.g., the processor 120) may transfer the synchronization information to the external electronic device (e.g., the first external electronic device 202 and/or the second external electronic device 204).

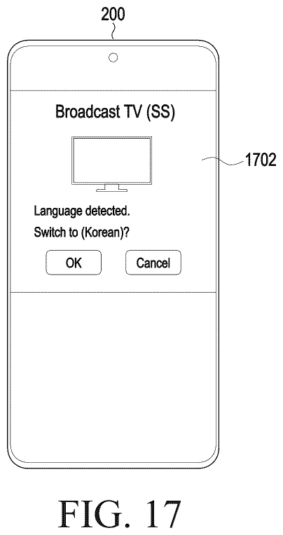

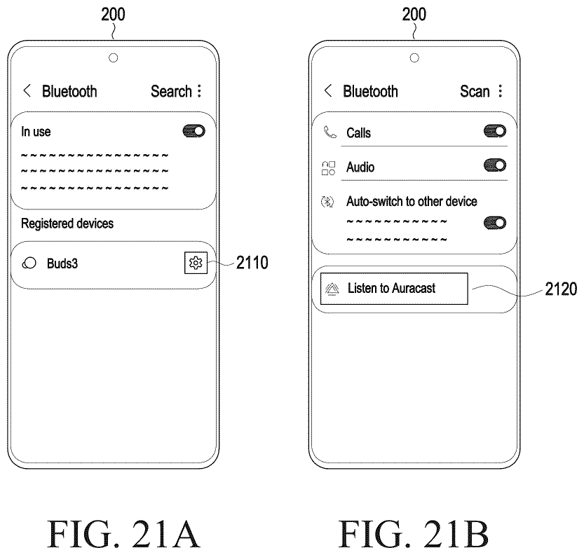

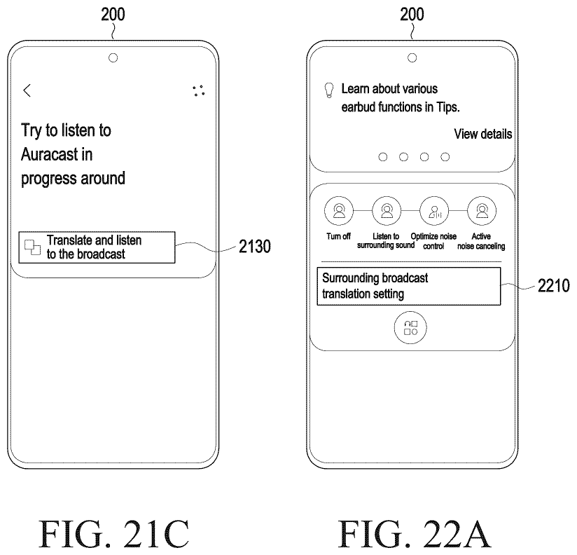

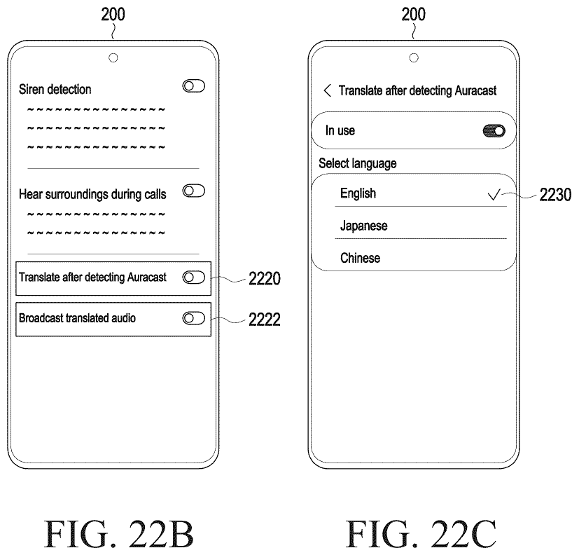

In operation 1406, the electronic device 200 (e.g., the processor 120) may synchronize with the BIS service from the source electronic device and receive the first audio data (e.g., BIS data packets) broadcast from the source electronic device. In an embodiment, the electronic device 200 (e.g., the processor 120) may receive the first audio data by synchronizing with the BIS service from the source electronic device 400 based on the synchronization information. In an embodiment, the electronic device 200 (e.g., the processor 120) may start to receive the first audio data based on determining to start the translation service related to the BIS service. In an embodiment, the electronic device 200 (e.g., the processor 120) may determine to start the translation service based on a user input through a UI (e.g., the translation service selection UI 1702 of FIG. 17, the translation listening UI 2130 of FIG. 21C, or the translation language selection UI 2230 of FIG. 22C). In an embodiment, the electronic device 200 (e.g., the processor 120) may determine to start the translation service based on the first language representing the first audio data being different from the designated second language (e.g., the default language set for the electronic device 200 or the language selected by the user).

In an embodiment, the electronic device 200 (e.g., the processor 120) may receive PA data (e.g., the AUX_SYNC_IND packet 506) related to the BIS service broadcast from the source electronic device 400 based on the synchronization information, and receive the first audio data broadcast from the source electronic device 400 using BIG information (e.g., BIG information 600 of FIG. 6) obtained from the PA data.

In an embodiment, the electronic device 200 (e.g., the processor 120) may identify that the first audio data is represented in the first language (e.g., the first audio data may include spoken words in the first language, or the first audio data is related to the first language). In an embodiment, the electronic device 200 (e.g., the processor 120) may automatically detect that the first audio data is represented in the first language through a language identification (LID) result of the first audio data. In an embodiment, the electronic device 200 (e.g., the processor 120) may identify that the first audio data is represented in the first language based on language information included in BIS-related information (e.g., at least one of PA data, AUX_SYNC_IND 506, or BIG information 600) related to the first audio data.

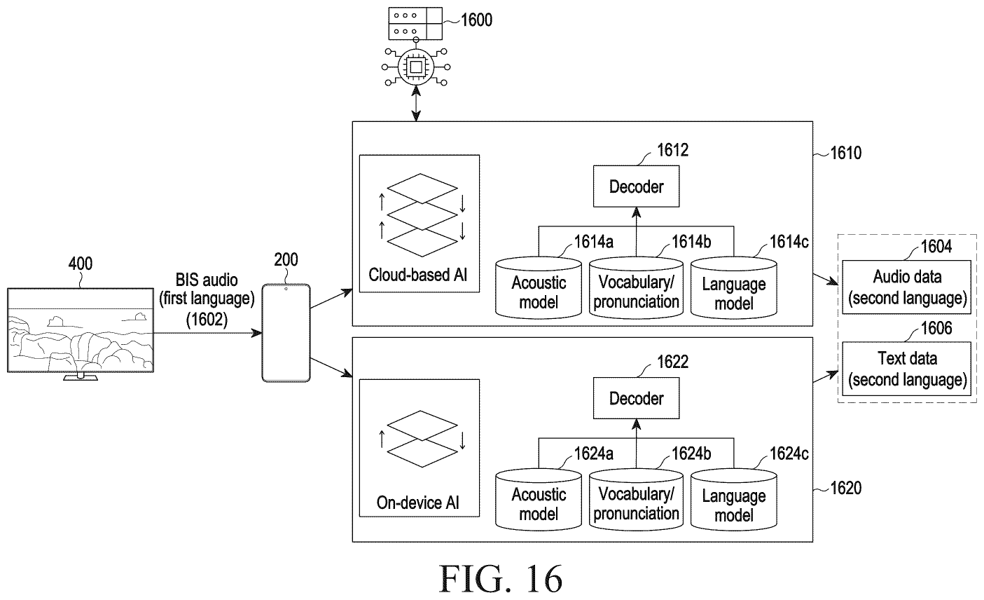

In operation 1408, the electronic device 200 (e.g., the processor 120) may translate the first audio data into second audio data represented in the second language. In an embodiment, the second language may be, e.g., a default language set for the electronic device 200 or a language selected by the user. In an embodiment, the electronic device 200 (e.g., the processor 120) may display a translation language selection user interface (UI) (e.g., the translation language selection UI 2230) indicating at least one translatable language to start the translation service, and may receive a user input for selecting the second language through the language selection UI. In an embodiment, the electronic device 200 (e.g., the processor 120) may translate the first audio data into the second audio data using a cloud-based artificial intelligence (AI) algorithm (e.g., the cloud-based AI translation algorithm 1610 of FIG. 16) or an on-device AI algorithm (e.g., the on-device AI translation algorithm 1620 of FIG. 16).

In operation 1410, the electronic device 200 (e.g., the processor 120) may transmit the second audio data to the external electronic device (e.g., the first external electronic device 202 and/or the second external electronic device 204). In an embodiment, the electronic device 200 (e.g., the processor 120) may transmit the second audio data to the external electronic device (e.g., the first external electronic device 202 and/or the second external electronic device 204) through the at least one wireless communication link (e.g., the first CIS link 1106 and/or the second CIS link 1108) established in operation 1402. In an embodiment, the electronic device 200 (e.g., the processor 120) may generate a BIG including at least one BIS for transmitting the second audio data and broadcast the second audio data through the at least one BIS.

In an embodiment, the external electronic device (e.g., the first external electronic device 202 and/or the second external electronic device 204) may receive the second audio data (e.g., CIS data packets) through the wireless communication link (e.g., the first CIS link 1106 and/or the second CIS link 1108). In an embodiment, the external electronic device (e.g., the first external electronic device 202 and/or the second external electronic device 204) may synchronize with the BIG from the electronic device 200 and receive the second audio data broadcast through the BIG. In an embodiment, the external electronic device (e.g., the first external electronic device 202 and/or the second external electronic device 204) may output the second audio data through a speaker (e.g., the speaker 354).

In an embodiment, the external electronic device (e.g., the first external electronic device 202 and/or the second external electronic device 204) may output the second audio data together with audio data directly received from the source electronic device 400 (e.g., by mixing), or output the second audio data in place of audio data directly received from the source electronic device 400. In an embodiment, the external electronic device (e.g., the first external electronic device 202 and/or the second external electronic device 204) may reduce the volume of audio data received directly from the source electronic device 400 and output the second audio data at a higher volume.

In an embodiment, the external electronic device (e.g., the first external electronic device 202 and/or the second external electronic device 204) may stop synchronizing with the BIS service from the source electronic device 400 and output only the second audio data while receiving the second audio data from the electronic device 200. In an embodiment, the external electronic device (e.g., the first external electronic device 202 and/or the second external electronic device 204) may stop directly receiving BIS audio data while maintaining synchronization for the BIS service. In an embodiment, although direct reception of audio data from the source electronic device 400 is stopped, the external electronic device (e.g., the first external electronic device 202 and/or the second external electronic device 204) may maintain BIS synchronization based on PA data from the source electronic device 400 to quickly resume reception of BIS audio data from the source electronic device 400.

In an embodiment, the electronic device 200 (e.g., the processor 120) may transmit control information indicating a method of outputting the second audio data to the external electronic device (e.g., the first external electronic device 202 and/or the second external electronic device 204) before transmitting the second audio data or together with the second audio data. In an embodiment, the control information may instruct the external electronic device to output the second audio data together with, or instead of, audio data directly received from the source electronic device 400.

In an embodiment, the control information may include latency information based on the BIG information received from the source electronic device 400 by the electronic device 200. In an embodiment, the latency information may include at least one of a start time of BIS audio data (e.g., BIS audio data 1304), a latency with the image reproduced by the source electronic device 400, or a start offset for translation support. In an embodiment, the electronic device 200 may determine the latency information further considering the time required to translate the first audio data into the second audio data.

In an embodiment, the external electronic device (e.g., the first external electronic device 202 and/or the second external electronic device 204) may synchronize the time when the electronic device 200 reproduces the image data from the source electronic device 400 with the time when the electronic device 200 reproduces the translated audio data by reproducing the audio data received from the electronic device 200 using the latency information. In an embodiment, the electronic device 200 may display the translated text corresponding to the BIS audio data to be synchronized with the BIS audio data (e.g., the BIS audio data 1304) based on the latency information.

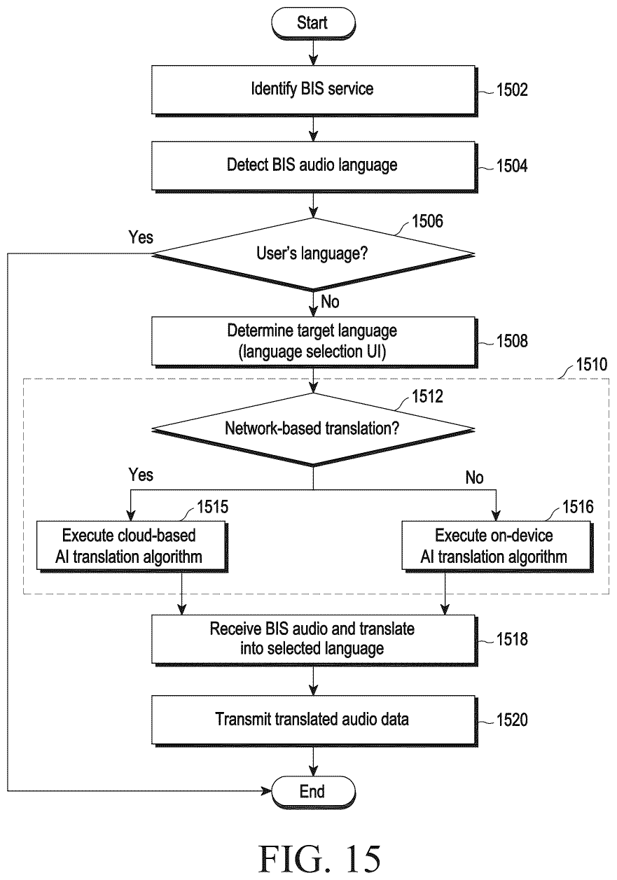

FIG. 15 is a flowchart illustrating a procedure of providing a translation service based on language identification according to an example embodiment. According to embodiments, at least one of operations to be described below may be omitted, modified, or executed in a different order. At least one of the operations described below may be executed by a processor (e.g., the processor 120 of FIG. 1) of the electronic device 200 (e.g., the electronic device 101 of FIG. 1). In an embodiment, the memory (e.g., the memory 130 of FIG. 1) of the electronic device 200 may store instructions that enable the electronic device 200 to operate according to at least one of the operations described below.

Referring to FIG. 15, in operation 1502, the electronic device 200 (e.g., the processor 120) may identify the presence of a BIS service provided by the source electronic device 400 by receiving advertising data (e.g., EA data and/or PA data) broadcast from the source electronic device 400. In an embodiment, the electronic device 200 (e.g., the processor 120) may select at least one BIS service to be synchronized by the external electronic device (e.g., the first external electronic device 202 and/or the second external electronic device 204) among at least one BIS service that may be provided by the source electronic device 400 based on the advertising data. In an embodiment, the electronic device 200 (e.g., the processor 120) may transmit synchronization information related to the selected BIS service to the external electronic device (e.g., the first external electronic device 202 and/or the second external electronic device 204) to synchronize with the BIS service based on the synchronization information.

In operation 1504, the electronic device 200 (e.g., the processor 120) may detect the BIS audio language related to the BIS service. In an embodiment, the electronic device 200 (e.g., the processor 120) may identify that the BIS audio language is the first language (e.g., English) based on language information included in PA data (e.g., AUX_SYNC_IND 506) related to the BIS service. In an embodiment, the electronic device 200 (e.g., the processor 120) may identify that the BIS audio language is the first language (e.g., English) based on the language identification result for the BIS audio data received based on the PA data.

In operation 1506, the electronic device 200 (e.g., the processor 120) may determine whether the first language is the same as the user's language (e.g., the second language). In an embodiment, the user's language may be a default language set for the electronic device 200. When it is identified that the first language is different from the user's language, the electronic device 200 (e.g., the processor 120) may proceed to operation 1508. When the first language and the user's language are the same, the electronic device 200 (e.g., the processor 120) may terminate the procedure. In an embodiment, the electronic device 200 (e.g., the processor 120) may determine to start the translation service by receiving a user input requesting to start the translation service instead of performing operation 1506.

In operation 1508, the electronic device 200 (e.g., the processor 120) may receive a user input for selecting a target language (e.g., the second language) for translation through a translation language selection UI (e.g., the translation language selection UI 2230) indicating at least one language capable of providing a translation service.

In operation 1510, the electronic device 200 (e.g., the processor 120) may execute a translation algorithm for translating the first language into the second language. In an embodiment, operation 1510 may include at least one of operation 1512, operation 1514, or operation 1516. In operation 1512, the electronic device 200 (e.g., the processor 120) may determine whether the electronic device 200 will perform a network-based translation service. When the network-based translation service is performed, in operation 1514, the electronic device 200 (e.g., the processor 120) may execute a cloud-based AI translation algorithm (e.g., the cloud-based AI translation algorithm 1610 of FIG. 16). If the network-based translation service is not performed, in operation 1516, the electronic device 200 (e.g., the processor 120) may execute an on-device AI translation algorithm (e.g., the on-device AI translation algorithm 1620 of FIG. 16).

In operation 1518, the electronic device 200 (e.g., the processor 120) may receive BIS audio data related to the BIS service by synchronizing with the BIS service from the source electronic device 400 based on the advertising data (e.g., EA data and/or PA data) received in operation 1502, and may translate the BIS audio data into a language selected by the user (e.g., the second language) through the cloud-based AI translation algorithm or the on-device AI translation algorithm.

In operation 1520, the electronic device 200 (e.g., the processor 120) may transmit the translated audio data. In an embodiment, the electronic device 200 (e.g., the processor 120) may transmit the translated audio data through at least one wireless communication link (e.g., the first CIS link 1106 and/or the second CIS link 1108) for audio transmission. In an embodiment, the electronic device 200 (e.g., the processor 120) may generate a BIG including at least one BIS for transmitting the translated audio data and broadcast the translated audio data through the at least one BIS, thereby allowing the external electronic device (e.g., the first external electronic device 202 and/or the second external electronic device 204) to receive the broadcast translated audio data.

In an embodiment, the electronic device 200 (e.g., the processor 120) may generate data packets (e.g., CIS data packets or BIS data packets) including the translated audio data. In an embodiment, the data packets may include control information for outputting the translated audio data, together with the translated audio data, by the external electronic device (e.g., the first external electronic device 202 and/or the second external electronic device 204). The first external electronic device 202 and/or the second external electronic device 204 may output the translated audio data to be synchronized with the audio data directly received from the source electronic device 400 based on the control information.

In an embodiment, when the translated audio data is transmitted through at least one CIS link, the electronic device 200 may receive an ack for audio data (e.g., a CIS data packet) transmitted for each CIS link as a response and determine whether the CIS data packet is normally received through the ack. The electronic device 200 may retransmit the unbacked CIS data packet at a flush point calculated by combining CIS parameters (e.g., burst number (BN), number of subevents (NSE), and flushing time (FT)) determined in the procedure for establishing a CIS link (e.g., the procedure of FIG. 12). When the anchor point toggle is set, the electronic device 200 may toggle the anchor point with respect to a designated unit time period and transmit the CIS audio data (e.g., CIS data packets) at the toggled anchor point. The external electronic device (e.g., the first external electronic device 202 and/or the second external electronic device 204) may receive CIS data packets including audio translated from the electronic device 200 based on the CIS parameters determined through the procedure of establishing the CIS link (e.g., the procedure of FIG. 12).

In an embodiment, the external electronic device (e.g., the first external electronic device 202 and/or the second external electronic device 204) may receive CIS data packets including audio translated from the electronic device 200 through the first CIS link 1106 and/or the second CIS link 1108, and transmit an acknowledgment (ack) for the CIS data packets through the first CIS link 1106 and/or the second CIS link 1108.

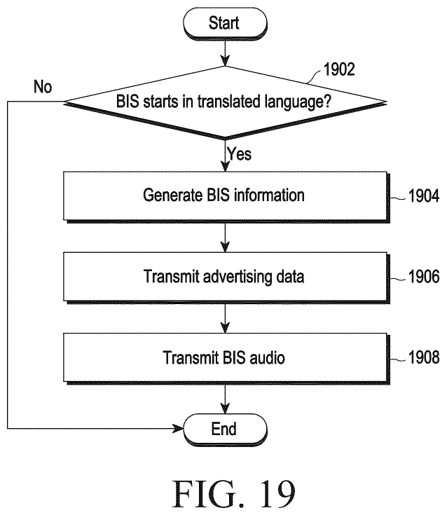

In an embodiment, the electronic device 200 may act as a BIS source that receives and translates the BIS audio data broadcast by the source electronic device 400 and broadcasts the translated audio data. In an embodiment, the electronic device 200 may broadcast BIS data packets including the translated audio data according to BIG information (e.g., BIG information 600 of FIG. 6) broadcast by the source electronic device 400 according to the procedure of FIG. 19.

FIG. 16 is a view illustrating an AI translation algorithm according to an example embodiment.

Referring to FIG. 16, the electronic device 200 may receive the BIS audio data 1602 represented in the first language from the source electronic device 400 and translate the BIS audio data 1602 into the audio data 1604 represented in the second language using a cloud-based AI translation algorithm 1610 or an on-device AI translation algorithm 1620. In an embodiment, the electronic device 200 may configure the cloud-based AI translation algorithm 1610 or the on-device AI translation algorithm 1620 to operate in the second language selected by the user.

In an embodiment, the electronic device 200 may identify the first language representing the BIS audio data 1602 from language information included in BIS-related information (e.g., the BIS information 600) related to the BIS audio data 1602, or based on a language identification result for the BIS audio data 1602. In an embodiment, the electronic device 200 may identify the target second language for translation based on user setting information, or identify the target second language for translation based on a user input directly received from the user. In an embodiment, the second language may be a default language set for the electronic device 200.

In an embodiment, the electronic device 200 may execute the cloud-based AI translation algorithm 1610 or the on-device AI translation algorithm 1620 according to whether network-based translation is available. In an embodiment, the electronic device 200 may execute the cloud-based AI translation algorithm 1610 when the use of the data network is allowed and, otherwise, may execute the on-device AI translation algorithm 1620 otherwise.

In an embodiment, the cloud-based AI translation algorithm 1610 may include a decoder 1612, and the decoder 1612 may translate the BIS audio data 1602 into audio data 1604 represented in the second language using an acoustic model 1614a, a vocabulary pronunciation model 1614b, and/or a language model 1614c that may be trained by the cloud server 1600. In an embodiment, the decoder 1612 may generate text data 1606 represented in the second language and the audio data 1604 represented in the second language, translated from the BIS audio data 1602.

In an embodiment, the cloud-based AI translation algorithm 1620 may include a decoder 1622, and the decoder 1622 may use the acoustic model 1624a, the vocabulary pronunciation model 1624b, and/or the language model 1624c that may be trained inside the electronic device 200 to translate the BIS audio data 1602 into audio data 1604 represented in the second language. In an embodiment, the decoder 1622 may generate text data 1606 represented in the second language and the audio data 1604 represented in the second language, translated from the BIS audio data 1602.

FIG. 17 is a view illustrating a translation service selection UI according to an example embodiment.

Referring to FIG. 17, the electronic device 200 may discover the source electronic device 400 providing the BIS service and display a translation service selection UI 1702 for inquiring whether to perform the translation service for the BIS service. In an embodiment, the electronic device 200 may identify the first language (e.g., English) representing the BIS service from PA data related to the BIS service, and display the translation service selection UI 1702 based on the first language being different from the second language (e.g., Korean) set by the electronic device 200. Based on receiving a user input requesting to execute a translation service through the translation service selection UI 1702, the electronic device 200 may receive the BIS audio data broadcast from the source electronic device 400 and translate the received BIS audio data.

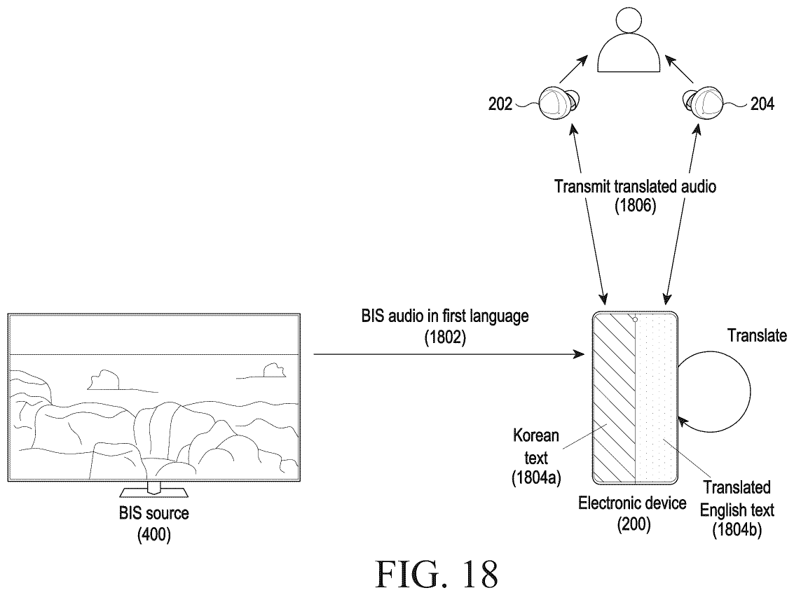

FIG. 18 is a view illustrating an operation of displaying translated text according to an example embodiment.

Referring to FIG. 18, the electronic device 200 may translate the BIS audio data 1802 in the first language (e.g., Korean) received from the source electronic device 400 into audio data in the second language (e.g., English) while simultaneously generating first text data (e.g., Korean text 1804a) represented in the first language and second text data (e.g., translated English text 1804b) represented in the second language.

In an embodiment, the electronic device 200 may generate the Korean text 1804a corresponding to the BIS audio data 1802 through speech recognition on the BIS audio data 1802. In an embodiment, the electronic device 200 may generate the translated English text 1804b (e.g., text data 1606) corresponding to the BIS audio data 1802 by executing a translation algorithm (e.g., cloud-based AI translation algorithm 1610 or on-device AI translation algorithm 1620) using the BIS audio data 1802 as an input. In an embodiment, the translated English text 1804b may include text having the same content as that of the BIS audio data 1802, or may include text having content summarized by an AI algorithm.

In an embodiment, the electronic device 200 may display at least one of the Korean text 1804a or the translated English text 1804b through a display (e.g., the display module 160). The electronic device 200 may display at least one of the Korean text 1804a or the translated English text 1804b to synchronize with the translated audio data 1806 output by the external electronic device while transmitting the translated audio data 1806 to the external electronic device (e.g., the first external electronic device 202 and/or the second external electronic device 204). The user may recognize the Korean text 1804a and/or the translated English text 1804b through the display (e.g., the display module 160) of the electronic device 200 while listening to the translated audio through the external electronic device. In an embodiment, the electronic device 200 may display at least one of the Korean text 1804a or the translated English text 1804b without transmitting the translated audio data 1806.

In an embodiment, the electronic device 200 may display second text data (e.g., translated English text 1804b) represented in the second language at a later time than the first text data while displaying the first text data (e.g., the Korean text 1804a) represented in the first language corresponding to the BIS audio data 1802 in the first language (e.g., Korean) received from the source electronic device 400. In an embodiment, when displaying the second text data, the electronic device 200 may emphasize (e.g., highlight or color) a corresponding portion of the first text data matching the second text data and display the same. In an embodiment, the electronic device 200 may emphasize (e.g., highlight or color) portions corresponding to the same content of the first text data and the second text data and display the same.

In an embodiment, the electronic device 200 may start displaying the text (e.g., the translated English text 1804b) corresponding to the translated audio based on a change in audio output attributes (e.g., audio volume down and/or mute setting) of the external electronic device by a user input while transmitting the translated audio to the external electronic device (e.g., the first external electronic device 202 and/or the second external electronic device 204). In an embodiment, the electronic device 200 may receive the user input through an input device (e.g., a touch screen) of the electronic device 200 or through an input device 330 of the external electronic device (e.g., the first external electronic device 202 and/or the second external electronic device 204).

In an embodiment, the electronic device 200 may display the translated text (e.g., the translated English text 1804b) and at least a portion of information related to the translated text in synchronization with the translated audio 1806 output from the external electronic device (e.g., the first external electronic device 202 and/or the second external electronic device 204). In an embodiment, the information related to the translated text may include at least one of image, video, or text information generated or searched based on the translated text. For example, information related to the translated text may include information related to the singer of the song provided by the BIS audio data 1802, information related to the movie provided by the BIS audio data 1802, or information related to athletes and/or teams related to the sports broadcast provided by the BIS audio data 1802. In an embodiment, the electronic device 200 may execute a designated application based on identifying that a designated keyword is included in the BIS audio data 1802. In an embodiment, the BIS audio data 1802 may include airport audio announcement, and the electronic device 200 may execute an indoor navigation application based on the airport audio announcement including a phrase for directing to move in a specific direction.

FIG. 19 is a view illustrating a procedure of broadcasting a translated audio according to an example embodiment. According to embodiments, at least one of the operations to be described below may be omitted, modified, or executed in a different order. At least one of the operations described below may be executed by a processor (e.g., the processor 120 of FIG. 1) of the electronic device 200 (e.g., the electronic device 101 of FIG. 1). In an embodiment, the memory (e.g., the memory 130 of FIG. 1) of the electronic device 200 may store instructions that enable the electronic device 200 to operate according to at least one of the operations described below.

Referring to FIG. 19, in operation 1902, the electronic device 200 (e.g., the processor 120) may determine whether to start a BIS service with the translated audio (e.g., the audio data 1604 translated into the second language) obtained through at least one of the above-described embodiments. In an embodiment, the electronic device 200 (e.g., the processor 120) may determine to start the BIS service based on a user input requesting to start the BIS service.

In an embodiment, the electronic device 200 (e.g., the processor 120) may determine to start the BIS service based on a user option designating to start the BIS service when the translation service is started. In an embodiment, the electronic device 200 (e.g., the processor 120) may determine to start the BIS service based on the number of external electronic devices (e.g., the first external electronic device 202, the second external electronic device 204, and/or the third external electronic device 2000) receiving the translated audio through the CIS exceeding a designated threshold value. In an embodiment, the electronic device 200 (e.g., the processor 120) may determine to start the BIS service based on identifying difficulty in generating a new CIS due to lack of communication resources (e.g., communication circuitry, or frequency resources).

When the BIS service is not started, the electronic device 200 (e.g., the processor 120) may terminate the procedure. When it is determined to start the BIS service, the electronic device 200 (e.g., the processor 120) may proceed to operation 1904.

In operation 1904, the electronic device 200 may generate first BIG information (e.g., BIG information 600) including BIG parameters related to the BIG to generate a BIG including at least one subgroup for the BIS service. In an embodiment, the electronic device 200 may determine an anchor point, which is a starting point of BIS data transmission, to be the same as an anchor point of the BIS service transmitted by the source electronic device 400, by referring to the second BIG information (e.g., BIG information obtained in operation 1302) related to the BIS service transmitted by the source electronic device 400. Information (e.g., BIG_Offset) related to the determined anchor point may be included in the BIG information.

In an embodiment, the electronic device 200 may add a subgroup for translated audio in the BIG provided by the source electronic device 400 and transmit BIS data packets including the translated audio through a BIG/BIS event of the added subgroup. The additional subgroup for the translated audio may be time-synchronized (e.g., at the same anchor point) and transmitted by using a common timing reference to the subgroup related to the first audio data in the BIG. In an embodiment, the electronic device 200 may add a subgroup for translated audio in the BIG provided by the source electronic device 400, and transmit BIS data packets including first audio data received from the source electronic device 400 and second audio data including the translated audio.

In operation 1906, the electronic device 200 may broadcast advertising data (e.g., PA data, or AUX_SYNC_IND packet 506) including the first BIG information. In an embodiment, the first BIG information (e.g., AUX_SYNC_IND packet 506) may include language information indicating the language (e.g., the second language) representing the translated audio transmitted by the electronic device 200.

In operation 1908, the electronic device 200 may start transmitting BIS data packets including the translated audio based on the first BIG information. At least one external electronic device (e.g., the third external electronic device 2000) positioned around the electronic device 200 may discover the electronic device 200 acting as the BIS source based on the advertising data broadcast by the electronic device 200 and receive BIS data packets including translated audio broadcast from the electronic device 200. In an embodiment, the BIS data packets may include translated audio data corresponding to the BIS audio data received by the electronic device 200 from the source electronic device 400 and/or translated text data corresponding to the BIS audio data. In an embodiment, the third external electronic device 2000 may be an electronic device (e.g., smart glasses) including a display, and may display the translated text data.

In an embodiment, the electronic device 200 may provide a BIS service including audio data represented in one or more languages. The electronic device 200 may include language information (e.g., “BIS1_Korean”) about a plurality of languages in the first BIG information, and may provide a translation service desired by the user by transmitting BIS audio data including audio translated according to a designated condition (e.g., the language selected by the user).

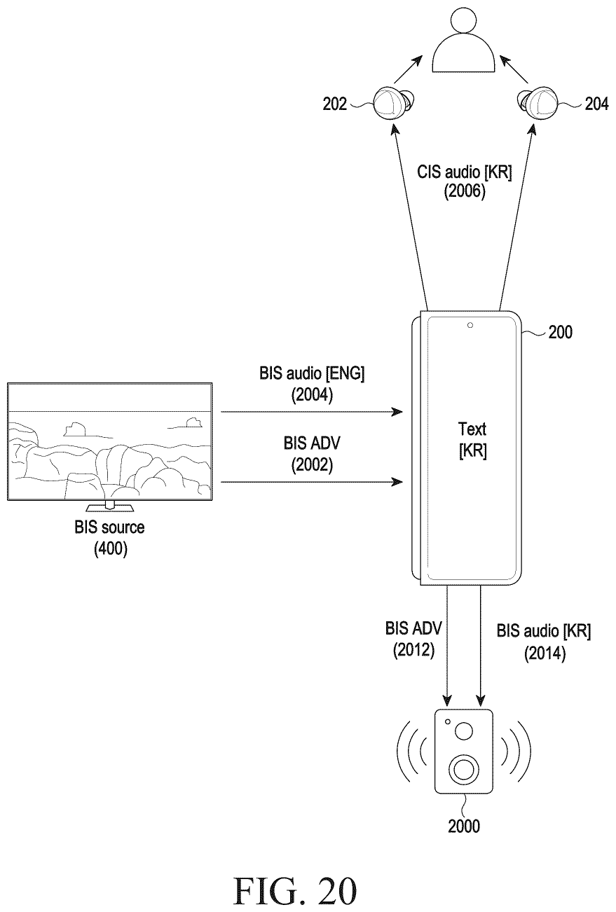

FIG. 20 is a view illustrating broadcasting a translated audio according to an example embodiment.

Referring to FIG. 20, the electronic device 200 may receive BIS audio data 2004 in the first language (e.g., English) broadcast from the source electronic device 400 based on the advertising data 2002 received from the source electronic device 400. The electronic device 200 may transmit audio data translated from the BIS audio data 2004 to the external electronic device (e.g., the first external electronic device 202 and/or the second external electronic device 204) through at least one wireless communication link. In an embodiment, the electronic device 200 may generate CIS audio data 2006 (e.g., CIS data packets) including the translated audio data, and transmit the CIS audio data 2006 to the first external electronic device 202 and/or the second external electronic device 204 through at least one CIS link (e.g., the first CIS link 1106 and/or the second CIS link 1108).

In an embodiment, based on determining to start the BIS service of the translated audio, the electronic device 200 may broadcast BIS data packets 2014 including advertising data 2012 related to the BIS service and translated audio data (e.g., Korean audio data). The advertising data 2012 may include synchronization information for synchronizing the translated audio data with the BIS audio data 2004 transmitted by the source electronic device 400. In an embodiment, the advertising data 2012 may indicate a BIS channel name (e.g., “BIS1_Korean”) including the language representing the translated audio data. In an embodiment, the advertising data 2012 may include at least a portion of translated text data (e.g., Korean text data) corresponding to the BIS audio data 2004 in the first language (e.g., English).

In an embodiment, the external electronic device (e.g., the third external electronic device 2000) may discover the electronic device 200 acting as the BIS source based on receiving the advertising data 2012, and may receive BIS data packets 2014 including the translated audio data from the electronic device 200 based on the advertising data 2012. The third external electronic device 2000 may output the translated audio data included in the BIS data packets 2014 through a speaker (e.g., the speaker 354). In an embodiment, the third external electronic device 2000 may output the translated audio data to be synchronized with the audio output from the first external electronic device 202 and/or the second external electronic device 204 (e.g., the BIS audio data 2004 received from the source electronic device 400 by the first external electronic device 202 and/or the second external electronic device 204, and/or the CIS audio data 2006 received from the electronic device 200 by the first external electronic device 202 and/or the second external electronic device 204).

In an embodiment, the third external electronic device 2000 may be an electronic device including a display, and the electronic device 200 may broadcast BIS data packets 2014 including translated text data (e.g., Korean text data) together with advertising data 2012 related to the BIS service and translated audio data. In an embodiment, the third external electronic device 2000 may display the translated text data to be synchronized with the audio output from the first external electronic device 202 and/or the second external electronic device 204.

In an embodiment, the external electronic device (e.g., the first external electronic device 202, the second external electronic device 204, or the third external electronic device 200) may search whether there is an additional BIS for transmitting an audio stream translated in relation to the BIS audio data 2004 while receiving the BIS audio data 2004 broadcast from the source electronic device 400. In an embodiment, the external electronic device may receive the advertising data 2012 broadcast from the electronic device 200 while directly receiving the BIS audio data 2004 broadcast from the source electronic device 400 and identify that the BIS audio data 2014 broadcast from the electronic device 200 may include translated audio related to the BIS audio data 2004 broadcast from the source electronic device 400 based on the advertising data. In an embodiment, the external electronic device may receive the BIS audio data 2014 broadcast from the electronic device 200 based on the advertising data 2012.

Through example embodiments, the user may use an audio service translated through the external electronic device (e.g., the first external electronic device 202 and/or the second external electronic device 204). Through example embodiments, a translation service may be provided by utilizing the processing resources of the electronic device 200.

In an embodiment, the electronic device 200 may display translation setting UIs (e.g., the translation listening UI 2130 of FIG. 21C or the automatic translation setting UI 2220 of FIG. 22B and the translation language selection UI 2230) for setting a translation service according to example embodiments. In an embodiment, the electronic device 200 may provide the translation setting UIs through a pop-up menu, a notification bar, and/or a toast message.

FIGS. 21A, 21B, and 21C are views illustrating a UI for selecting a translation service through a Bluetooth setting according to an example embodiment.

Referring to FIG. 21A, the electronic device 200 may display a Bluetooth setting UI 2110 for the external electronic device (e.g., the first external electronic device 202 and/or the second external electronic device 204) among Bluetooth devices that may be connected to the electronic device 200.

Referring to FIG. 21B, the electronic device 200 may display a broadcast listening UI 2120 (e.g., “listen to Auracast”) for selecting the start of the broadcast service based on a user input (e.g., touch) to the Bluetooth setting UI 2110.

Referring to FIG. 21C, the electronic device 200 may display a translation listening UI 2130 (e.g., “translate and listen to broadcast”) for selecting a translation service based on a user input (e.g., touch) to the broadcast listening UI 2120. The electronic device 200 may determine to start the translation service according to example embodiments based on a user input (e.g., touch) to the translation listening UI 2130.

FIGS. 22A, 22B, and 22C are views illustrating a UI for selecting a translation service through a device setting according to an example embodiment.

Referring to FIG. 22A, the electronic device 200 may display the surrounding broadcast translation setting UI 2210 through execution of a dedicated application for the external electronic device (e.g., the first external electronic device 202 and/or the second external electronic device 204).

Referring to FIG. 22B, the electronic device 200 may display the automatic translation setting UI 2220 (e.g., “translate after detecting Auracast”) based on a user input (e.g., touch) to the surrounding broadcast translation setting UI 2210. In an embodiment, the electronic device 200 may display the broadcast setting UI 2222 (e.g., “broadcast translated audio”) of the translated audio together with the automatic translation setting UI 2220. In an embodiment, the electronic device 200 may display or activate the broadcast setting UI 2222 of the translated audio based on the activation of “translate after detecting Auracast” through the automatic translation setting UI 2220.

Referring to FIG. 22C, the electronic device 200 may display the translation language selection UI 2230 based on a user input (e.g., a touch) to the automatic translation setting UI 2220. The translation language selection UI 2230 may include input objects (e.g., “English, Japanese, and/or Chinese”) representing target languages for translation by the electronic device 200. Based on receiving a user input for selecting a target language (e.g., the second language) for translation through any one of the input objects, the electronic device 200 may determine to automatically provide a translation service related to the BIS service. In an embodiment, the electronic device 200 may automatically broadcast (e.g., generate and broadcast a BIS) the translated audio generated through the translation service while providing the translation service based on a user input (e.g., a touch) to the broadcast setting UI 2222 of the translated audio.

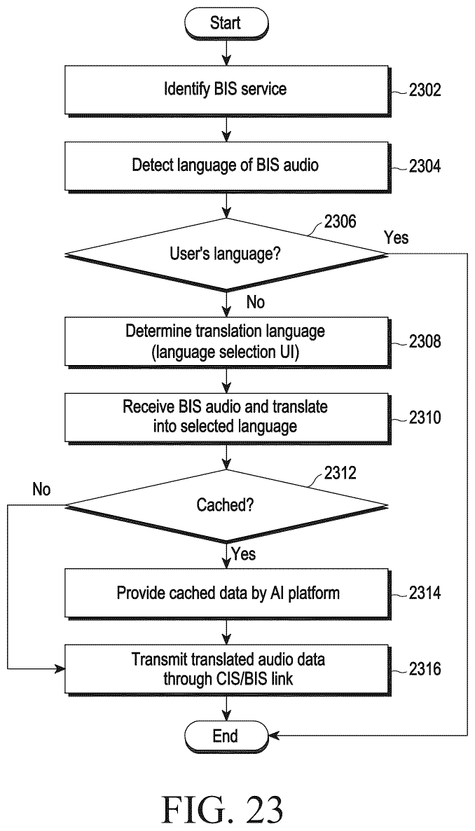

FIG. 23 is a flowchart illustrating a procedure for providing a translation service based on caching of translated data according to an embodiment. According to embodiments, at least one of operations described below may be omitted, modified, or performed in a different order. In an embodiment, at least one of the operations described below may be performed by a processor (e.g., the processor 120 of FIG. 1) of an electronic device 200 (e.g., the electronic device 101 of FIG. 1). In an embodiment, memory (e.g., the memory 130 of FIG. 1) of the electronic device 200 may store instructions that cause the electronic device 200 to operate according to at least one of the operations described below.

Referring to FIG. 23, in operation 2302, the electronic device 200 (e.g., the processor 120) may identify the presence of a BIS service provided by a source electronic device 400 by receiving advertising data (e.g., EA data and/or PA data) broadcast from the source electronic device 400. In an embodiment, the electronic device 200 (e.g., the processor 120) may receive broadcast information (e.g., the BIG information 600 of FIG. 6) related to the identified BIS service, synchronize to the BIS service (e.g., BIG) based on the BIG information, and then receive BIS audio data (e.g., a BIS audio data stream) through the BIS service.

In operation 2304, the electronic device 200 (e.g., the processor 120) may detect a BIS audio language related to the BIS service. In an embodiment, the electronic device 200 (e.g., the processor 120) may identify that the BIS audio language is a first language (e.g., English) based on language information included in PA data (e.g., AUX_SYNC_IND 506) related to the BIS service. In an embodiment, the electronic device 200 (e.g., the processor 120) may identify that the BIS audio language is the first language (e.g., English) based on a language identification result for BIS audio data received based on the PA data.

In operation 2306, the electronic device 200 (e.g., the processor 120) may determine whether the first language is the same as the user's language (e.g., a second language). In an embodiment, the user's language may be a default language set in the electronic device 200. When identifying that the first language is different from the user's language, the electronic device 200 (e.g., the processor 120) may proceed to operation 2308. When the first language is the same as the user's language, the electronic device 200 (e.g., the processor 120) may terminate the procedure. In an embodiment, the electronic device 200 (e.g., the processor 120) may decide to start a translation service by receiving a user input requesting to start the translation service instead of performing operation 2306.

In operation 2308, the electronic device 200 (e.g., the processor 120) may receive a user input for selecting a language to be translated (e.g., a second language) through a translation language selection UI (e.g., the translation language selection UI 2230) indicating at least one language capable of providing a translation service.

In operation 2310, the electronic device 200 (e.g., the processor 120) may receive BIS audio data related to the BIS service and translate the BIS audio data into a language selected by the user (e.g., a second language) through a cloud-based AI translation algorithm (e.g., the cloud-based AI translation algorithm 1610 of FIG. 16) or the on-device AI translation algorithm 1620 of FIG. 16. In an embodiment, operation 2310 may correspond to operation 1510.

In operation 2312, the electronic device 200 (e.g., the processor 120) may determine whether to cache the BIS audio data before translation (e.g., raw audio data) and the translated audio data in memory (e.g., the memory 130 of FIG. 1). In an embodiment, the electronic device 200 may enable or disable a cache function for the raw audio data and the translated audio data based on a user setting. When the cache function is disabled, the electronic device 200 may proceed to operation 2316. When the cache function is enabled, the electronic device 200 may proceed to operation 2314.

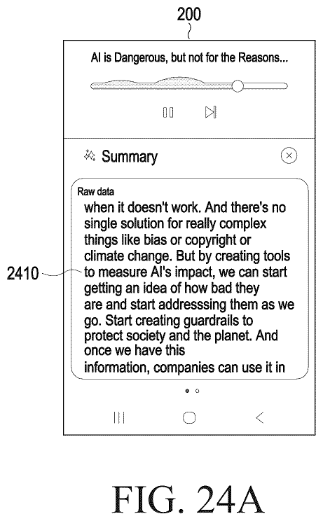

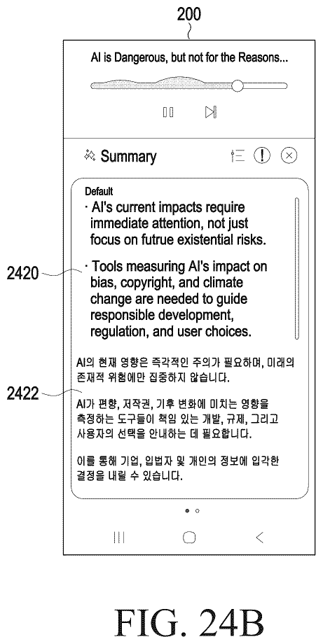

In operation 2314, the electronic device 200 (e.g., the processor 120) may leverage the cached data (e.g., BIS audio data before translation and translated audio data) by an AI platform (e.g., an AI algorithm). In an embodiment, the cached data may be utilized and processed for various purposes according to a user request. In an embodiment, operation 2314 may include an operation of displaying the UI of FIGS. 24A and/or 24B.

In operation 2316, the electronic device 200 (e.g., the processor 120) may transmit the translated audio data. In an embodiment, the electronic device 200 (e.g., the processor 120) may transmit the translated audio data through at least one wireless communication link for audio transmission (e.g., the first CIS link 1106 and/or the second CIS link 1108). In an embodiment, the electronic device 200 (e.g., the processor 120) may generate a BIG including at least one BIS for transmission of the translated audio data and broadcast the translated audio data through the at least one BIS, thereby causing an external electronic device (e.g., the first external electronic device 202 and/or the second external electronic device 204) to receive the broadcast translated audio data. In an embodiment, operation 2316 may correspond to operation 1520.

In an embodiment, when a translation algorithm (e.g., the cloud-based AI translation algorithm 1610 or the on-device AI translation algorithm 1620) is completed, the electronic device 200 may store BIS audio data before translation (e.g., raw audio data) and translated audio data in the memory 130 (e.g., cache memory) so that they may be utilized according to a user intention. In an embodiment, the electronic device 200 may store raw audio data and translated audio data for a designated time period in cache memory so that information missed by the user or previously received audio data may be utilized according to a user intention.

In an embodiment, the electronic device 200 may cache the raw audio data and the translated audio data in a circumstance where an audio service is being used through a background operation, not in a circumstance where the audio service is being used through a foreground operation. In an embodiment, a foreground operation may refer to a circumstance where an audio service is being received while a screen of the electronic device 200 is turned on or audio is being output, and a background operation may refer to a circumstance where an audio service is being received while the screen of the electronic device 200 is turned off or audio is not being output. In an embodiment, cached data during a foreground operation (e.g., raw data and translated data) and cached data during a background operation (e.g., raw data and translated data) may be distinguished by a designated flag. In an embodiment, cached data during a foreground operation may be stored together with the flag set to a first value, and cached data during a background operation may be stored together with the flag set to a second value.

In an embodiment, the electronic device 200 may provide the cached data (e.g., raw data and translated data cached during a foreground operation and/or a background operation) to a user through an AI platform (e.g., cloud-based AI or on-device AI). In an embodiment, the electronic device 200 may select data suitable for a user intention from among the cached data based on an AI platform and display the selected data. In an embodiment, the cached data may include raw data directly selected and received by the user (e.g., audio data received during a foreground operation) and its translated data, and raw data received at a time not intended by the user (e.g., audio data received during a background operation) and its translated data.

FIGS. 24A and 24B are views illustrating a UI of a translation service utilizing cached data according to an embodiment of the disclosure.

Referring to FIG. 24A, the electronic device 200 may display English text data 2410 corresponding to raw audio data received through the audio service while receiving an audio service related to English content. In an embodiment, the electronic device 200 may cache raw audio data and translated audio data (e.g., Korean audio data) corresponding to the audio service and text data corresponding thereto while receiving the audio service from beginning to end through a foreground operation.

Referring to FIG. 24B, after receiving the audio service to the end, the electronic device 200 may obtain the raw audio data and the translated audio data from cache memory based on a user input requesting a summary of English content related to the audio service or based on identifying termination of the audio service, process the raw audio data and the translated audio data by an AI platform to generate summarized data (e.g., an English summary text 2420 and/or a Korean summary text 2422), and display the summarized data. In an embodiment, the summarized data may take various formats that are pre-designated or selected by the user in at least one form of text, audio, or sign language.

In an embodiment, the electronic device 200 may receive raw audio data corresponding to at least a portion (e.g., a front part) of the audio service through a background operation, cache the raw audio data and translated audio data corresponding thereto, and receive raw audio data corresponding to the remaining portion (e.g., a rear part) of the audio service through a foreground operation, and cache the raw audio data and translated audio data corresponding thereto. In an embodiment, the electronic device 200 may provide (e.g., display) summary data corresponding to cached raw audio data and translated audio data corresponding to the background operation to a user during reception of the audio service (e.g., the rear part) or after the audio service is terminated. In an embodiment, raw audio data and/or translated audio data may be displayed together with or instead of the summary data. In an embodiment, the electronic device 200 may read cached raw audio data and translated audio data corresponding to a background operation based on a flag among data stored in cache memory, and process the read audio data by an AI platform to generate the summary data.

A method for controlling an electronic device (e.g., a host device or a portable terminal) according to an example embodiment may comprise establishing a wireless communication link between the electronic device and a wearable device, receiving a first audio control signal broadcast from an external electronic device, configuring a screen for selecting audio using at least a portion of the first audio control signal and displaying the screen on a display, selecting one audio among the at least one audio based on a user's first input, transferring a second audio control signal related to the selected audio to the connected wearable device through the wireless communication link so that the wearable device receives and reproduces the selected audio broadcast from the external device, and providing content related to the selected audio to the user.

In an embodiment, providing the content related to the selected audio to the user may further include detecting that the language set for the selected audio is different from the language set for the electronic device, by the electronic device, displaying a translation-related user selection screen on the display, receiving the selected audio broadcast from the external electronic device in response to the user's second input, translating the selected audio to generate a translated audio, and transferring the translated audio to the wearable device through the wireless communication link.

In an embodiment, the method may further comprise controlling the wearable device to synchronize and reproduce the selected audio broadcast from the external electronic device and the translated audio, by the electronic device.

In an embodiment, detecting that the language set for the selected audio is different from the language set for the electronic device by the electronic device may include identifying set language-related information about the selected audio in at least one audio-related control signal received by the electronic device and compare the identified information with the language set for the electronic device.

In an embodiment, detecting that the language set for the selected audio is different from the language set for the electronic device by the electronic device may be performed based on a control-related signal received from the wearable device by the electronic device.

In an embodiment, detecting that the language set for the selected audio is different from the language set for the electronic device by the electronic device may include receiving the selected audio broadcast from the external electronic device by the electronic device, identify the language of the received audio, and compare the identified language with the language set for the electronic device.

In an embodiment, the method may further comprise broadcasting the translated audio to be received by a third electronic device.

In an embodiment, the broadcasting operation may include transmitting the translated audio as the electronic device operates as a BIS source.

In an embodiment, the method may further comprise generating text corresponding to the translated audio and displaying the generated text on at least a portion of the display based on changing the audio output attribute by the user's third input.

In an embodiment, changing the audio output attribute may include adjusting the level of the audio volume.

In an embodiment, changing the audio output attribute may include activating a mute setting.

In an embodiment, the translation-related user selection screen may be displayed together with the audio selection screen.

In an embodiment, the wireless communication link may be a Bluetooth (BT) based link.

In an embodiment, the audio-related control signal may include at least some of information associated with the BIS, or EA/PA information.

In an embodiment, the information associated with the BIS may include information for BIS synchronization.

In an embodiment, the audio-related control signal may include audio content-related information.

In an embodiment, the audio content-related information may include language information.

In an embodiment, providing the content related to the selected audio to the user may further include detecting that the language set for the selected audio is different from the language set for the electronic device, by the electronic device, displaying a translation-related user selection screen on the display, receiving the selected audio broadcast from the external electronic device in response to the user's second input, generating translated text by translating the selected audio, and displaying at least some of the translated text and information related to the translated text in synchronization with the selected audio reproduced on the wearable device, on at least a portion of the display.

In an embodiment, the information related to the translated text may include at least one of additional image, video or text information generated or searched based on the translated text.

An electronic device 200 according to an embodiment may comprise a communication circuit 192 configured to support Bluetooth communication, memory 130 storing instructions, and at least one processor 120, comprising processing circuitry, operatively connected directly or indirectly to the communication circuit and the memory. The instructions may, when executed by the at least one processor individually or collectively, cause the electronic device to receive, through the communication circuitry, synchronization information associated with reception of a broadcast isochronous stream (BIS) service from a source electronic device 400. The instructions may, when executed by the at least one processor individually or collectively, cause the electronic device to transmit, through the communication circuitry, the synchronization information to an external electronic device (202, 204), so that the external electronic device is capable of synchronizing with the source electronic device based on the synchronization information and receiving audio data broadcasted from the source electronic device. The instructions may, when executed by the at least one processor individually or collectively, cause the electronic device to receive, through the communication circuitry, first audio data for the BIS service broadcasted from the source electronic device. The instructions may, when executed by the at least one processor individually or collectively, cause the electronic device to, based on identifying that the first audio data is represented in a first language and the first language is different from a designated second language, translate the first audio data into second audio data represented in the second language. The instructions may, when executed by the at least one processor individually or collectively, cause the electronic device to establish, through the communication circuitry, a wireless communication link for audio transmission with the external electronic device. The instructions may, when executed by the at least one processor individually or collectively, cause the electronic device to transmit the second audio data to the external electronic device through the wireless communication link, so that the external electronic device outputs the second audio data.

In an embodiment, the instructions may cause the electronic device to, based on at least one of a language identification (LID) result of the first audio data or BIS-related information received at a time indicated by the synchronization information, identify that the first audio data is represented in the first language and compare the first language with the second language, which is a language selected by a first user input or a default language set for the electronic device, to determine that the first language is different from the second language.

In an embodiment, the instructions may cause the electronic device to generate text data represented in the second language corresponding to the second audio data and display, through a display 160 of the electronic device, the text data so as to be synchronized with the second audio data output from the external electronic device.

In an embodiment, the instructions may cause the electronic device to, based on receiving a second user input for changing an audio output setting related to the external electronic device, generate the text data. Changing the audio output setting may include at least one of adjusting an audio volume or activating a mute setting.

In an embodiment, the instructions may cause the electronic device to display information related to the text data together with the text data. The information related to the text data may include at least one of an image, a video, or text generated or searched based on the text data.

In an embodiment, the instructions may cause the electronic device to transmit, to the external electronic device, control information that instructs the external electronic device to output the second audio data together with audio data directly received from the source electronic device, or to output the second audio data instead of the audio data directly receives from the source electronic device.

In an embodiment, the instructions may cause the electronic device to, based on identifying that the first language is different from the second language, display a translation language selection user interface (UI) for selecting a translation into the second language.

In an embodiment, the synchronization information may include at least one of control information related to at least one BIS where the first audio data is broadcast, extended advertising (EA) information related to the at least one BIS, and periodic advertising (PA) information related to the at least one BIS.

In an embodiment, the wireless communication link may include at least one connected isochronous stream (CIS). In an embodiment, the instructions may cause the electronic device to generate CIS data packets including the second audio data and control information used for synchronizing the second audio data with the first audio data, and transmit the CIS data packets to the external electronic device through the at least one CIS.

In an embodiment, the instructions may cause the electronic device to, by acting as a BIS source, broadcast BIS data packets including the second audio data, so that at least one first external electronic device 2000 receives the BIS data packets.

In an embodiment, the instructions may cause the electronic device to translate the first audio data into the second audio data using a cloud-based artificial intelligence (AI) translation algorithm or an on-device AI translation algorithm.

According to an embodiment, in a non-transitory, computer-readable storage medium storing one or more programs, the one or more programs may include instructions that, when individually or collectively executed by at least one processor 120, cause an electronic device 200 to receive synchronization information associated with reception of a broadcast isochronous stream (BIS) service from a source electronic device 400, transmit the synchronization information to an external electronic device 202, 204, so that the external electronic device is capable of synchronizing with the source electronic device based on the synchronization information and receiving audio data broadcasted from the source electronic device, receive first audio data for the BIS service broadcasted from the source electronic device, based on identifying that the first audio data is represented in a first language and identifying the first language is different from a designated second language, translate the first audio data into second audio data represented in the second language, establishing a wireless communication link for audio transmission with the external electronic device, and transmit the second audio data to the external electronic device through the wireless communication link, so that the external electronic device outputs the second audio data.

In an embodiment, the instructions may cause the electronic device to, based on at least one of a language identification (LID) result of the first audio data or BIS-related information received at a time indicated by the synchronization information, identify that the first audio data is represented in the first language and compare the first language with the second language, which is a language selected by a first user input or a default language set for the electronic device, to determine that the first language is different from the second language.

In an embodiment, the instructions may cause the electronic device to generate text data represented in the second language corresponding to the second audio data and display, through a display 160 of the electronic device, the text data so as to be synchronized with the second audio data output from the external electronic device.

In an embodiment, the instructions may cause the electronic device to, based on receiving a second user input for changing an audio output setting related to the external electronic device, generate the text data. Changing the audio output setting may include at least one of adjusting an audio volume or activating a mute setting. In an embodiment, the instructions may cause the electronic device to display information related to the text data together with the text data. The information related to the text data may include at least one of an image, a video, or text generated or searched based on the text data.

In an embodiment, the instructions may cause the electronic device to transmit, to the external electronic device, control information that instructs the external electronic device to output the second audio data together with audio data directly received from the source electronic device, or to output the second audio data instead of the audio data directly receives from the source electronic device.

In an embodiment, the instructions may cause the electronic device to, based on identifying that the first language is different from the second language, display a translation language selection UI for selecting a translation into the second language.

In an embodiment, the synchronization information may include at least one of control information related to at least one BIS where the first audio data is broadcast, extended advertising (EA) information related to the at least one BIS, and periodic advertising (PA) information related to the at least one BIS.

In an embodiment, the wireless communication link may include at least one connected isochronous stream (CIS). In an embodiment, the instructions may cause the electronic device to generate CIS data packets including the second audio data and control information used for synchronizing the second audio data with the first audio data, and transmit the CIS data packets to the external electronic device through the at least one CIS.

In an embodiment, the instructions may cause the electronic device to, by acting as a BIS source, broadcast BIS data packets including the second audio data, so that at least one first external electronic device 2000 receives the BIS data packets.

The electronic device according to various example embodiments may be one of various types of electronic devices. The electronic devices may include, for example, a portable communication device (e.g., a smartphone), a computer device, a portable multimedia device, a portable medical device, a camera, a wearable device, or a home appliance. According to an example embodiment, the electronic devices are not limited to those described above.

It should be appreciated that various example embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. Thus, for example, “connected” as used herein covers both direct and indirect connections.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various example embodiments may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each embodiment herein may be used in combination with any other embodiment(s) described herein.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
communication circuitry configured to support Bluetooth communication;
memory storing instructions; and
at least one processor, comprising processing circuitry, operatively connected to the communication circuitry and the memory, wherein the instructions, when executed by the at least one processor individually or collectively, cause the electronic device to:
receive, through the communication circuitry, synchronization information associated with reception of a broadcast isochronous stream (BIS) service from a source electronic device;
transmit, through the communication circuitry, the synchronization information to an external electronic device, so that the external electronic device can be capable of synchronizing with the source electronic device based on the synchronization information and receiving audio data broadcasted from the source electronic device;
receive, through the communication circuitry, first audio data for the BIS service broadcasted from the source electronic device;
based on identifying that the first audio data is represented in a first language and the first language is different from a designated second language, translate the first audio data into second audio data represented in the second language; and
transmit the second audio data to the external electronic device through the communication circuitry, so that the external electronic device can output the second audio data.

2. The electronic device of claim 1, wherein the instructions cause the electronic device to:
based on at least one of a language identification (LID) result of the first audio data or BIS-related information received at a time indicated by the synchronization information, identify that the first audio data is represented in the first language; and
compare the first language with the second language, which is a language selected by a first user input and/or a default language set for the electronic device, to determine that the first language is different from the second language.

3. The electronic device of claim 1, wherein the instructions cause the electronic device to:
based on receiving at least one of a designated user setting, a user input requesting a text service, or a second user input for changing an audio output setting related to the external electronic device, generate text data represented in the second language corresponding to the second audio data; and
display, through a display (160) of the electronic device, the text data so as to be synchronized with the second audio data output from the external electronic device, and
wherein changing the audio output setting includes at least one of adjusting an audio volume or activating a mute setting.

4. The electronic device of claim 3, wherein the instructions cause the electronic device to:
display information related to the text data together with the text data, and
wherein the information related to the text data includes at least one of an image, a video, or text generated or searched based on the text data.

5. The electronic device of claim 1, wherein the instructions cause the electronic device to:
cache the first audio data and the second audio data corresponding to a designated time period;
generate summary data corresponding to the cached data based on an artificial intelligence (AI) algorithm, wherein the summary data includes audio data and/or text data represented in the first language and/or the second language; and
provide the summary data to a user based on a designated user setting or a user input.

6. The electronic device of claim 1, wherein the instructions cause the electronic device to:
transmit, to the external electronic device, control information for instructing the external electronic device to output the second audio data together with audio data directly received from the source electronic device, and/or to output the second audio data instead of the audio data directly receives from the source electronic device.

7. The electronic device of claim 1, wherein the instructions cause the electronic device to:
based on identifying that the first language is different from the second language, display a translation language selection user interface (UI) for selecting a translation into the second language.

8. The electronic device of claim 1, wherein the synchronization information comprises at least one of:
control information related to at least one BIS where the first audio data is broadcast, extended advertising (EA) information related to the at least one BIS, and/or periodic advertising (PA) information related to the at least one BIS.

9. The electronic device of claim 1, wherein the instructions cause the electronic device to:
establish, through the communication circuitry, at least one connected isochronous stream (CIS) for audio transmission with the external electronic device;
generate CIS data packets including the second audio data and control information to be used for synchronizing the second audio data with the first audio data; and
transmit the CIS data packets to the external electronic device through the at least one CIS.

10. The electronic device of claim 1, wherein the instructions cause the electronic device to:
by acting as a BIS source, broadcast BIS data packets including the second audio data, so that at least one first external electronic device can receive the BIS data packets.

11. The electronic device of claim 1, wherein the instructions cause the electronic device to:
translate the first audio data into the second audio data using at least a cloud-based artificial intelligence (AI) translation algorithm and/or an on-device AI translation algorithm.

12. A non-transitory, computer-readable storage medium storing one or more programs, wherein the one or more programs includes instructions that, when individually or collectively executed by at least one processor, cause an electronic device to:
receive synchronization information associated with reception of a broadcast isochronous stream (BIS) service from a source electronic device;
transmit the synchronization information to an external electronic device, so that the external electronic device can be capable of synchronizing with the source electronic device based on the synchronization information and receiving audio data broadcasted from the source electronic device;
receive first audio data for the BIS service broadcasted from the source electronic device;
based on identifying that the first audio data is represented in a first language and the first language is different from a designated second language, translate the first audio data into second audio data represented in the second language; and
transmit the second audio data to the external electronic device so that the external electronic device can output the second audio data.

13. The non-transitory, computer-readable storage medium of claim 12, wherein the instructions cause the electronic device to:
based on at least one of a language identification (LID) result of the first audio data or BIS-related information received at a time indicated by the synchronization information, identify that the first audio data is represented in the first language; and
compare the first language with the second language, which is a language selected by a first user input and/or a default language set for the electronic device, to determine that the first language is different from the second language.

14. The non-transitory, computer-readable storage medium of claim 12, wherein the instructions cause the electronic device to:
based on receiving at least one of a designated user setting, a user input requesting a text service, or a second user input for changing an audio output setting related to the external electronic device, generate text data in the second language corresponding to the second audio data;
display, through a display (160) of the electronic device, the text data so as to be synchronized with the second audio data output from the external electronic device, wherein changing the audio output setting including at least one of adjusting an audio volume or activating a mute setting; and
display information related to the text data together with the text data, the information related to the text data including at least one of an image, a video, or text generated or searched based on the text data.

15. The non-transitory, computer-readable storage medium of claim 12, wherein the instructions cause the electronic device to:
cache the first audio data and the second audio data corresponding to a designated time period;
generate summary data corresponding to the cached data based on an artificial intelligence (AI) algorithm, wherein the summary data includes audio data and/or text data represented in the first language and/or the second language; and
provide the summary data to a user based on a designated user setting or a user input.

16. The non-transitory, computer-readable storage medium of claim 12, wherein the instructions cause the electronic device to transmit, to the external electronic device, control information for instructing the external electronic device to output the second audio data together with audio data directly received from the source electronic device, and/or to output the second audio data instead of the audio data directly received from the source electronic device.

17. The non-transitory, computer-readable storage medium of claim 12, wherein the instructions cause the electronic device to, based on identifying that the first language is different from the second language, display a translation language selection UI for selecting a translation into the second language.

18. The non-transitory, computer-readable storage medium of claim 12, wherein the synchronization information comprises at least one of control information related to at least one BIS where the first audio data is broadcast, extended advertising (EA) information related to the at least one BIS, and/or periodic advertising (PA) information related to the at least one BIS.

19. The non-transitory, computer-readable storage medium of claim 12, wherein the instructions cause the electronic device to:
establish at least one connected isochronous stream (CIS) for audio transmission with the external electronic device;
generate CIS data packets including the second audio data and control information to be used for synchronizing the second audio data with the first audio data; and
transmit the CIS data packets to the external electronic device through the at least one CIS.

20. The non-transitory, computer-readable storage medium of claim 12, wherein the instructions cause the electronic device to, by acting as a BIS source, broadcast BIS data packets including the second audio data so that at least one first external electronic device can receive the BIS data packets.
